(19) United States
(12) Patent Application Publication
(10) Pub. No.: US 2010/0082646 A1
(43) Pub. Date: Apr. 1, 2010

(54) TRACKING CONSTRAINTS AND DEPENDENCIES ACROSS MAPPING LAYERS

(75) Inventors: Colin Meek, Redmond, WA (US); Nadejda Poliakova, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/239,104

(22) Filed: Sep. 26, 2008

(51) Int. Cl. G06F 17/30

(52) U.S. Cl. 707/752; 707/E17.055

(57) ABSTRACT

Techniques for object relational mapping (ORM) are provided. A dependency graph generator receives a combination of object level custom commands and store level dynamic commands. Each store level dynamic command is generated from at least one object level dynamic command. An identifier is assigned to each entity present in the object level custom commands and the object level dynamic commands. A store level dynamic command includes any identifiers assigned in the corresponding object level dynamic command(s). The dependency graph generator is configured to generate a dependency graph that includes nodes and at least one edge coupled between a corresponding pair of nodes. Each node is associated with a corresponding store level dynamic command or an object level custom command. An edge is configured according to an identifier associated with the corresponding pair of nodes and a dependency between commands associated with the corresponding pair of nodes.

### BACKGROUND

Bridging applications and databases is a longstanding problem. In 1996, Carey and DeWitt outlined why many technologies, including object-oriented databases and persistent programming languages, did not gain wide acceptance due to limitations in query and update processing, transaction throughput, and scalability. They speculated that object-relational (O/R) databases would dominate in 2006. Indeed, DB2® and Oracle® database systems include a built-in object layer that uses a hardwired O/R mapping on top of a conventional relational engine. However, the O/R features offered by these systems appear to be rarely used for storing enterprise data, with the exception of multimedia and spatial data types. Among the reasons are data and vendor independence, the cost of migrating legacy databases, scale-out difficulties when business logic runs inside the database instead of the middle tier, and insufficient integration with programming languages.

Since mid 1990's, client-side data mapping layers have gained popularity, fueled by the growth of Internet applications. A core function of such a layer is to provide an updatable view that exposes a data model closely aligned with the application's data model, driven by an explicit mapping. Many commercial products and open source projects have emerged to offer these capabilities. Virtually every enterprise framework provides a client-side persistence layer (e.g., EJB (Enterprise JavaBeans™) in J2EE (Java Platform, Enterprise Edition)). Most packaged business applications, such as ERP (Enterprise Resource Planning) and CRM (Customer Relationship Management) applications, incorporate proprietary data access interfaces (e.g., BAPI (Business Application Programming Interface) in SAP R/3).

One widely used open source Object-Relational Mapping (ORM) framework for Java® is Hibernate®. It supports a number of inheritance mapping scenarios, optimistic concurrency control, and comprehensive object services. The latest release of Hibernate conforms to the EJB 3.0 standard, which includes the Java Persistence Query Language. On the commercial side, popular ORMs include Oracle TopLink® and LLBLGen®. The latter runs on the .NET platform. These and other ORMs are tightly coupled with the object models of their target programming languages.

BEA® recently introduced a new middleware product called the AquaLogic Data Services Platform® (ALDSP). It uses XML Schema for modeling application data. The XML data is assembled using XQuery from databases and web services. ALDSP's runtime supports queries over multiple data sources and performs client-side query optimization. The updates are performed as view updates on XQuery views. If an update does not have a unique translation, the developer needs to override the update logic using imperative code. ALDSP's programming surface is based on service data objects (SDO).

Today's client-side mapping layers offer widely varying degrees of capability, robustness, and total cost of ownership. Typically, the mapping between the application and database artifacts used by ORMs has vague semantics and drives case-by-case reasoning. A scenario-driven implementation limits the range of supported mappings and often yields a fragile runtime that is difficult to extend. Few data access solutions leverage data transformation techniques developed by the database community, and often rely on ad hoc solutions for query and update translation.

Database research has contributed many powerful techniques that can be leveraged for building persistence layers. And yet, there are significant gaps. Among the most critical ones is supporting updates through mappings. Compared to queries, updates are far more difficult to deal with as they need to preserve data consistency across mappings, may trigger business rules, and so on. Updates through database views are intrinsically hard: even for very simple views finding a unique update translation is rarely possible. As a consequence, commercial database systems and data access products offer very limited support for updatable views. Recently, researchers turned to alternative approaches, such as bidirectional transformations.

Traditionally, conceptual modeling has been limited to database and application design, reverse-engineering, and schema translation. Many design tools use UML (Unified Modeling Language). Recently, conceptual modeling has started to penetrate industry-strength data mapping solutions. For example, the concept of entities and relationships surfaces both in ALDSP and EJB 3.0. ALDSP overlays E-R (Entity-Relationship) style relationships on top of complex-typed XML data, while EJB 3.0 allows specifying relationships between objects using class annotations.

Schema mapping techniques are used in many data integration products, such as Microsoft® BizTalk Server®, IBM® Rational Data Architect®, and ETL® tools. These products allow developers to design data transformations or compile them from mappings to translate e-commerce messages or load data warehouses.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Techniques for object relational mapping are provided that enable handing of dependencies between commands at different mapping layers and the interleaving of commands from these different mapping layers. For example, identifiers may be assigned to entities and relationships provided in modification commands. The identifiers enable dependencies between commands to be tracked across different mapping layers, including between an application/object-level and a database/store-level.

Methods for object relational mapping are described. In one method, at least one object level custom command is generated for at least one object modification determined to be configured to be processed at an application level. At least one object level dynamic command is generated for at least one object modification determined to be configured to be processed at a store level. At least one object level dynamic command and the at least one object level custom command form a plurality of object level commands. An identifier is assigned to each entity present in the object level commands. A pair of the identifiers is assigned to each relationship present in the object level commands. The pair of identifiers assigned to a first relationship includes first and second identifiers respectively assigned to first and second entities included in the first relationship. The at least one object level dynamic command is converted to at least one store level dynamic command. A dependency graph is generated that includes a plurality of nodes and an edge coupled between a pair of nodes of the plurality of nodes. Each node is associated with a corresponding store level dynamic command or an object level custom command. The edge is configured according to an assigned identifier associated with the pair of nodes and a dependency between commands associated with the pair of nodes. A topological sort of the dependency graph is performed to determine an execution order of the store level dynamic commands and the object level custom commands. Note that the dependency graph may include any number of edges.

In one implementation, the edge may be configured according to a foreign key dependency between the commands associated with the pair of nodes. For instance, a first node may be determined that is associated with a first command to delete a primary key or to insert a foreign key. A second node is determined that is associated with a second command to delete a foreign key or to insert a primary key. The edge is coupled between the first and second nodes to have a direction from the second node to the first node.

In another implementation, the edge may be configured according to a common value dependency between the commands associated with the pair of nodes. For instance, a first node may be determined that is associated with a common value to be generated and an assigned identifier associated with the common value. A second node is determined that requires the generated common value to be received and includes the assigned identifier. The edge is coupled between the first and second nodes to have a direction from the first node to the second node.

In another implementation, the edge may be configured according to a model ordering dependency between the commands associated with the pair of nodes. For instance, a first node may be determined that is associated with a first command to insert an entity or to delete a relationship and that includes an assigned identifier. A second node is determined that is associated with a second command to insert a relationship or to delete the entity and that includes the assigned identifier. The edge is coupled between the first and second nodes to have a direction from the first node to the second node.

Systems for performing object relational mapping are also described. For instance, in one implementation, an object relational mapping (ORM) system includes a dependency graph generator. The dependency graph generator receives at least one object level custom command and at least one store level dynamic command. At least one store level dynamic command is generated from at least one object level dynamic command. An identifier is assigned to each entity present in the at least one object level custom command and to each entity present in the at least one object level dynamic command. At least one store level dynamic command includes any identifiers assigned in the at least one object level dynamic command. The dependency graph generator is configured to generate a dependency graph that includes a plurality of nodes and an edge coupled between a pair of nodes of the plurality of nodes. Each node is associated with a corresponding store level dynamic command or an object level custom command. The dependency graph generator is configured to configure the edge according to an assigned identifier associated with the pair of nodes and a dependency between commands associated with the pair of nodes.

Examples of the dependency include a foreign key dependency, a common value dependency, and a model ordering dependency.

In one implementation, the dependency graph generator may include a foreign key dependency edge determiner. The foreign key dependency edge determiner may be configured to determine a first node associated with a first command to delete a primary key or to insert a foreign key, to determine a second node associated with a second command to delete a foreign key or to insert a primary key, and to couple the edge between the first and second nodes to have a direction from the second node to the first node.

In another implementation the dependency graph generator may include a common value dependency edge determiner. The common value dependency edge determiner may be configured to determine a first node associated with a common value to be generated and an assigned identifier associated with the common value, to determine a second node that requires the generated common value to be received and includes the assigned identifier, and to couple the edge between the first and second nodes to have a direction from the first node to the second node.

In another implementation, the dependency graph generator may include a model ordering dependency edge determiner. The model ordering dependency edge determiner may be configured to determine a first node associated with a first command to insert an entity or to delete a relationship and that includes an assigned identifier, to determine a second node associated with a second command to insert a relationship or to delete the entity and that includes the assigned identifier, and to couple the edge between the first and second nodes to have a direction from the first node to the second node.

The ORM system may further include a topological sorter configured to perform a topological sort of the dependency graph to determine an execution order of the store level dynamic commands and the object level custom commands.

Computer program products are also described herein that enable object relational mapping as described herein.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIGS. 1 and 2 show example object relational mapping systems.

FIG. 3 illustrates an exemplary Entity Framework architecture.

FIG. 4 illustrates an exemplary relational schema.

FIG. 5 illustrates an exemplary Entity Data Model (EDM) schema.

FIG. 6 illustrates a mapping between an entity schema and a database schema.

FIG. 7 illustrates a mapping represented in terms of queries on the entity schema and the relational schema.

FIG. 8 illustrates bidirectional views (query and update views) generated by the mapping compiler for the mapping shown in FIG. 7.

FIG. 9 illustrates a process for leveraging materialized view maintenance algorithms to propagate updates through bidirectional views.

FIG. 10 illustrates a mapping designer user interface.

FIG. 11 shows a block diagram of an example mapping compiler.

FIG. 12 shows a block diagram of an “update” or “write” portion of an ORM runtime.

FIG. 13 shows a flowchart providing an example process for mapping application-level modification commands to store-level modification commands.

FIG. 14 shows a block diagram of an example ORM runtime portion, according to an embodiment.

FIG. 15 shows a flowchart providing an example process for mapping application-level modification commands to store-level modification commands, according to an example embodiment.

FIG. 16 shows an example object level custom command that may be generated for an object modification in an object graph.

FIG. 17 shows example first and second example object level dynamic commands that may be generated for an object modification in an object graph.

FIG. 18 illustrates an example of the assignment of identifiers, according to an embodiment.

FIG. 19 illustrates an example of the conversion of dynamic commands from object-level to store-level, according to an embodiment.

FIG. 20 shows a graphical representation of a dependency graph, according to an example embodiment.

FIG. 21 shows a block diagram of a dependency graph generator configured to generate edges based on foreign key dependencies, common value dependencies, and model ordering dependencies, according to an example embodiment.

FIG. 22 shows a flowchart for adding edges to a dependency graph based on foreign key dependencies, according to an example embodiment.

FIG. 23 shows a flowchart for adding edges to a dependency graph based on common value dependencies, according to an example embodiment.

FIG. 24 shows a flowchart for adding edges to a dependency graph based on model dependencies, according to an example embodiment.

FIGS. 25 and 26 illustrate graphical depictions of a dependency graph, according to example embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Object-relational mapping (ORM) is a technique for mapping data between relational databases and object-oriented programming languages. Data management tasks in object-oriented programming are typically implemented by manipulating objects, which are typically non-scalar values. For example, an address book entry may represent a single person along with zero or more phone numbers and zero or more addresses. The address book entry may be modeled in an object-oriented implementation by a “person object” having associated data objects representative of the address book entry, such as a person's name, a list (or array) of associated phone numbers, and a list of associated addresses. The address book entry/object may be handled as a single value by the programming language.

However, many popular database products, such as Microsoft SQL Server, cannot manipulate objects, and instead can only store and manipulate scalar values such as integers and strings organized within tables. For an application to manipulate the address book entry/object, either the data object values must be converted into groups of simpler values for storage in the database (and converted back upon retrieval), or the application itself must use simple scalar values. ORM may be used to implement the first approach, mapping objects to data and data to objects. For example, an ORM may map modifications of objects that occur due to commands of the application to modifications of data stored in the database. Typically, ORM systems use custom logic (e.g., “store procedures”) configured on an application-by-application basis to map changes to objects to changes to data in the database.

An ORM system, such as the ADO.NET Entity Framework published by Microsoft® Corporation, may be configured to enable data modification commands to be generated at multiple mapping layers. For example, modification commands to objects (also referred to as “models” and “entities” herein) may be generated by an application that accesses a database that stores data represented by the objects. Such modification commands to objects may be referred to as “application-level,” “custom,” or “customized” commands or operations. Modification commands to directly modify data tables (e.g., modifications to data table rows) in storage may be dynamically generated by an ORM system. Such dynamically created modification commands to data tables may be referred to as “store-level” or “dynamic” commands or operations.

Before executing data modification commands, it is often necessary to take into account dependencies and constraints between those commands. For instance, an ORM system may need to order data modification command execution based on constraints (e.g., foreign keys and uniqueness constraints) or dependencies (e.g., server-generated identifiers used to establish references in other objects, referred to as “common values” herein). Some ORM systems may need to be configured to handle such dependencies between commands at different mapping layers, including handling dependencies at the application-level and at the store-level. Conventional ORM systems are not capable of handling dependencies between commands at different mapping layers and interleaving commands from these different mapping layers.

Embodiments of the present invention overcome these deficiencies of conventional ORM systems, enabling the handing of dependencies between commands at different mapping layers and the interleaving of commands from these different mapping layers. The following section describes some example ORMs and environments in which embodiments of the present invention may be implemented, and example embodiments of the present invention are described in a subsequent section.

### II. Example Object Relational Mapper Systems

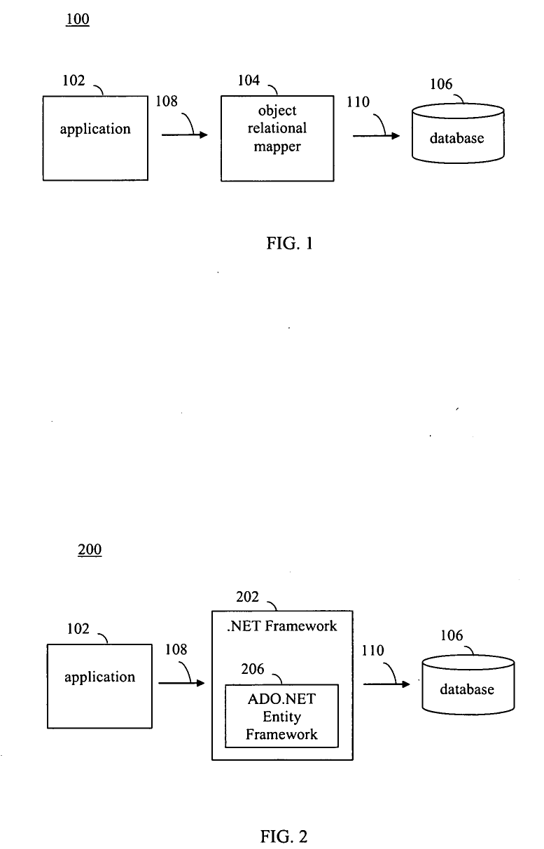

FIG. 1 shows an example ORM system 100. As shown in FIG. 1, ORM system 100 includes an application 102, an ORM 104, and a database 106. ORM system 100 is described as follows.

Application 102 may be any type of application that interacts with data stored in a database. Application 102 may be implemented in hardware, software, firmware, or any combination thereof. As shown in FIG. 1, application 102 generates an object level data modification command 108. Object level data modification command 108 contains a command for modifying one or more objects defined by application 102. Such modifications may include inserting a new object, deleting an object, and/or updating an object.

ORM 104 receives object level data modification command 108. ORM 104 is configured to map the command of object level data modification command 108 to modify one or more objects to a command to modify one or more data tables stored in database 106. ORM 104 may be implemented in hardware, software, firmware, or any combination thereof. Examples of ORM 104 include the ADO.NET Entity Framework published by Microsoft® Corporation of Redmond, Wash., Hibernate®, Oracle TopLink®, and LLBLGen®, developed by Solutions Design bv of The Hague, the Netherlands, and other commercially available or proprietary object relational mapping systems/tools mentioned elsewhere herein or otherwise known. As shown in FIG. 1, ORM 104 generates a store level data modification command 110.

Database 106 receives store level data modification command 110. Database 106 stores one or more data tables associated with application 102. Database 106 is configured to modify the one or more data tables stored in database 106 according to store level data modification command 110. For example, such modifications may include inserting a new row into a data table, deleting a row from a data table, and/or updating a row of a data table of database 106, corresponding to the object modifications defined in object level data modification command 108. Database 106 may be configured to be accessed according to the SQL (Structured Query Language) data definition and query language or by other suitable technique. Database 106 may include one or more physical and/or virtual storage devices used to store the data tables, including one or more hard disc drives, magnetic tape drives, optical disc drives, memory devices, etc.

In an embodiment, ORM 104 may be configured as an “Entity Framework.” An example of such an Entity Framework is the ADO.NET Entity Framework developed by Microsoft® Corporation. For instance, FIG. 2 shows an ORM system 200, which is an example of ORM system 100 shown in FIG. 1. In FIG. 2, ORM 104 (of FIG. 1) is the ADO.NET Entity Framework 206 contained in the .NET Framework 202, which is published by Microsoft® Corporation. The following subsections provide a general description of ADO.NET Entity Framework 206 along with many implementation-specific details which should not be considered necessary to practice all embodiments.

The description of ADO.NET Entity Framework 206 is provided for purposes of illustration, and is not intended to be limiting. Embodiments of the present invention may be implemented in ADO.NET Entity Framework 206 and/or in further types of ORMs mentioned elsewhere herein or otherwise known.

A. ADO.NET Entity Framework ORM

Traditional client-server applications relegate query and persistence operations on their data to database systems. The database system operates on data in the form of rows and tables, while the application operates on data in terms of higher-level programming language constructs (classes, structures etc.). The impedance mismatch in the data manipulation services between the application and the database tier was problematic even in traditional systems. With the advent of service-oriented architectures (SOA), application servers and multi-tier applications, the need for data access and manipulation services that are well-integrated with programming environments and can operate in any tier has increased tremendously.

Microsoft's ADO.NET Entity Framework is a platform for programming against data that raises the level of abstraction from the relational level to the conceptual (entity) level, and thereby significantly reduces the impedance mismatch for applications and data-centric services. Aspects of the Entity Framework, the overall system architecture, and the underlying technologies are described below.

1. Introduction

Modem applications require data management services in all tiers. They need to handle increasingly richer forms of data which includes not only structured business data (such as Customers and Orders), but also semi-structured and unstructured content such as email, calendars, files, and documents. These applications need to integrate data from multiple data sources as well as to collect, cleanse, transform and store this data to enable a more agile decision making process. Developers of these applications need data access, programming and development tools to increase their productivity. While relational databases have become the de facto store for most structured data, there tends to be a mismatch—the well-known impedance mismatch problem—between the data model (and capabilities) exposed by such databases, and the modeling capabilities needed by applications.

Two other factors also play an important part in enterprise system design. First, the data representation for applications tends to evolve differently from that of the underlying databases. Second, many systems are composed of disparate database back-ends with differing degrees of capability. The application logic in the mid-tier is responsible for data transformations that reconcile these differences and presenting a more uniform view of data. These data transformations quickly become complex. Implementing them, especially when the underlying data needs to be updatable, is a hard problem and adds complexity to the application. A significant portion of application development—up to 40% in some cases—is dedicated to writing custom data access logic to work around these problems.

The same problems exist, and are no less severe, for data-centric services.

Conventional services such as query, updates, and transactions have been implemented at the logical schema (relational) level. However, the vast majority of newer services, such as replication and analysis, best operate on artifacts typically associated with a higher-level, conceptual data model. For example, SQL SERVER® Replication invented a structure called “logical record” to represent a limited form of entity. Similarly, SQL Server Reporting Services builds reports on top of an entity-like data model called semantic data model language (SDML). Each of these services has custom tools to define conceptual entities and map them down to relational tables—a Customer entity will therefore need to be defined and mapped one way for replication, another way for report building, yet another way for other analysis services and so on. As with applications, each service typically ends up building a custom solution to this problem, and consequently, there is code duplication and limited interoperability between these services.

Object-to-relational mapping (ORM) technologies such as Hibernate® and Oracle Toplink® are a popular alternative to custom data access logic. The mappings between the database and applications are expressed in a custom structure, or via schema annotations. These custom structures may seem similar to a conceptual model; however, applications cannot program directly against this conceptual model. While the mappings provide a degree of independence between the database and the application, the problem of handling multiple applications with slightly differing views of the same data (e.g. consider two applications that want to look at different projections of a Customer entity), or of the needs of services which tend to be more dynamic (a priori class generation techniques do not work well for data services, since the underlying database may evolve quicker) are not well addressed by these solutions.

The ADO.NET Entity Framework is a platform for programming against data that significantly reduces the impedance mismatch for applications and data-centric services. It differs from other systems and solutions in at least the following respects:

1. The Entity Framework defines a rich conceptual data model (the Entity Data Model, or the EDM), and a new data manipulation language (Entity SQL) that operates on instances of this model. Like SQL, the EDM is value-based (i.e., the EDM defines the structural aspects of entities, and not the behaviors (or methods)).

2. This model is made concrete by a runtime that includes a middleware mapping engine supporting powerful bidirectional (EDM—Relational) mappings for queries and updates.

3. Applications and services may program directly against the value-based conceptual layer, or against programming-language-specific object abstractions that may be layered over the conceptual (entity) abstraction, providing ORM-like functionality. We believe a value-based EDM conceptual abstraction is a more flexible basis for sharing data among applications and data-centric services than objects.

4. Finally, the Entity Framework leverages Microsoft's new Language Integrated Query (LINQ) technologies that extend programming languages natively with query expressions to further reduce, and for some scenarios completely eliminate, the impedance mismatch for applications.

The ADO.NET Entity Framework can be incorporated into a larger framework such as the Microsoft .NET Framework.

The rest of this description of a data access architecture, in the context of an ADO.NET Entity Framework embodiment, is organized as follows. The “motivation” section provides additional motivation for the Entity Framework. The “Entity Framework” section presents the Entity Framework and the Entity Data Model. The “Programming Patterns” section describes programming patterns for the Entity Framework. The “Object Services” section outlines the Object Services module. The “Mapping” section focuses on the Mapping component of the Entity Framework, while the “Query Processing” and “Update Processing” sections explain how queries and updates are handled. The “Metadata” and “Tools” describe the metadata subsystem and the tools components of the Entity Framework.

2. Motivation

This section discusses why a higher level data modeling layer has become useful for applications and data-centric services.

Today's dominant information modeling methodologies for producing database designs factor an information model into four main levels: Physical, Logical (Relational), Conceptual, and Programming/Presentation.

The physical model describes how data is represented in physical resources such as memory, wire or disk. The vocabulary of concepts discussed at this layer includes record formats, file partitions and groups, heaps, and indexes. The physical model is typically invisible to the application—changes to the physical model should not impact application logic, but may impact application performance.

The logical data model is a complete and precise information model of the target domain. The relational model is the representation of choice for most logical data models. The concepts discussed at the logical level include tables, rows, primary-key/foreign-key constraints, and normalization. While normalization helps to achieve data consistency, increased concurrency, and better OLTP performance, it also introduces significant challenges for applications. Normalized data at the logical level is often too fragmented and application logic needs to assemble rows from multiple tables into higher level entities that more closely resemble the artifacts of the application domain.

The conceptual model captures the core information entities from the problem domain and their relationships. A well-known conceptual model is the Entity-Relationship Model introduced by Peter Chen in 1976. UML is a more recent example of a conceptual model. Most applications involve a conceptual design phase early in the application development lifecycle. Unfortunately, however, the conceptual data model diagrams stay “pinned to a wall” growing increasingly disjoint from the reality of the application implementation with time. An important goal of the Entity Framework is to make the conceptual data model (embodied by the Entity Data Model described in the next section) a concrete, programmable abstraction of the data platform.

The programming/presentation model describes how the entities and relationships of the conceptual model need to be manifested (presented) in different forms based on the task at hand. Some entities need to be transformed into programming language objects to implement application business logic; others need to be transformed into XML streams for web service invocations; still others need to be transformed into in-memory structures such as lists or dictionaries for the purposes of user-interface data binding. Naturally, there is no universal programming model or presentation form; thus, applications need flexible mechanisms to transform entities into the various presentation forms.

Most applications and data-centric services would like to reason in terms of high-level concepts such as an Order, not about the several tables that an order may be normalized over in a relational database schema. An order may manifest itself at the presentation/programming level as a class instance in Visual Basic or C# encapsulating the state and logic associated with the order, or as an XML stream for communicating with a web service. There is no one proper presentation model; the real value is in providing a concrete conceptual model, and then being able to use that model as the basis for flexible mappings to and from various presentation models and other higher level data services.

Data-based applications 10-20 years ago were typically structured as data monoliths; closed systems with logic factored by verb-object functions (e.g., create-order, update-customer) that interacted with a database system at the logical schema level.

Several significant trends have shaped the way that modern data-based applications are factored and deployed today. Chief among these are object-oriented factoring, service level application composition, and higher level data-centric services. Conceptual entities are an important part of today's applications. These entities must be mapped to a variety of representations and bound to a variety of services. There is no one correct representation or service binding: XML, Relational and Object representations are all important, but no single one suffices for all applications. There is a need, therefore, for a framework that supports a higher-level data modeling layer, and also allows multiple presentation layers to be plugged in-the Entity Framework aims to fulfill these requirements.

Data-centric services have also been evolving in a similar fashion. The services provided by a “data platform” 20 years ago were minimal and focused around the logical schema in an RDBMS. These services included query and update, atomic transactions, and bulk operations such as backup and load/extract.

SQL Server itself is evolving from a traditional RDBMS to a complete data platform that provides a number of high value data-centric services over entities realized at the conceptual schema level. Several higher-level data-centric services in the SQL Server product—Replication, Report Builder to name just a couple—are increasingly delivering their services at the conceptual schema level. Currently, each of these services has a separate tool to describe conceptual entities and map them down to the underlying logical schema level. One goal of the Entity Framework is to provide a common, higher-level conceptual abstraction that all of these services can share.

3. The Entity Framework

Microsoft's ADO.NET framework that existed prior to the Entity Framework described herein was a data-access technology that enabled applications to connect to data stores and manipulate data contained in them in various ways. It was part of the Microsoft .NET Framework and it was highly integrated with the rest of the .NET Framework class library. The prior ADO.NET framework had two major parts: providers and services. ADO.NET providers are the components that know how to talk to specific data stores. Providers are composed of three core pieces of functionality: connections manage access to the underlying data source; commands represent a command (query, procedure call, etc.) to be executed against the data source; and data readers represent the result of command execution. ADO.NET services include provider-neutral components such as DataSet to enable offline data programming scenarios. (A DataSet is a memory-resident representation of data that provides a consistent relational programming model regardless of the data source.)

3.1 Entity Framework—Overview

The ADO .NET Entity Framework builds on the pre-existing existing ADO.NET provider model, and adds a variety of novel functionality, for example:

1. A new conceptual data model, the Entity Data Model (EDM), to help model conceptual schemas.

2. A new data manipulation language (DML), Entity SQL, to manipulate instances of the EDM, and a programmatic representation of a query (canonical command trees) to communicate with different providers.

3. The ability to define mappings between the conceptual schema and the logical schemas.

4. An ADO.NET provider programming model against the conceptual schema.

5. An object services layer to provide ORM-like functionality.

6. Integration with LINQ technology to make it easy to program against data as objects from .NET languages.

3.2 The Entity Data Model

The Entity Data Model (EDM) is useful for developing rich data-centric applications. It extends the classic relational model with concepts from the entity-relationship (E-R) domain. Organizational concepts in the EDM include entities and relationships. Entities represent top-level items with identity, while Relationships are used to relate (or, describe relationships between) two or more entities.

The EDM is value-based like the relational model (and SQL), rather than object/reference-based like C# (CLR). Several object programming models can be easily layered on top of the EDM. Similarly, the EDM can map to one or more DBMS implementations for persistence.

The EDM and Entity SQL represent a richer data model and data manipulation language for a data platform and are intended to enable applications such as CRM and ERP, data-intensive services such as Reporting, Business Intelligence, Replication and Synchronization, and data-intensive applications to model and manipulate data at a level of structure and semantics that is closer to their needs. We now discuss various concepts pertaining to the EDM.

### EDM Types

An EntityType describes the structure of an entity. An entity may have zero or more properties (attributes, fields) that describe the structure of the entity. Additionally, an entity type must define a key—a set of properties whose values uniquely identify the entity instance within a collection of entities. An EntityType may derive from (or subtype) another entity type—the EDM supports a single inheritance model. The properties of an entity may be simple or complex types. A SimpleType represents scalar (or atomic) types (e.g., integer, string), while a ComplexType represents structured properties (e.g., an Address). A ComplexType is composed of zero or more properties, which may themselves be scalar or complex type properties. A RelationshipType describes relationships between two (or more) entity types. EDM Schemas provide a grouping mechanism for types—types must be defined in a schema. The namespace of the schema combined with the type name uniquely identifies the specific type.

### EDM Instance Model

Entity instances (or just entities) are logically contained within an EntitySet. An EntitySet is a homogeneous collection of entities, i.e., all entities in an EntitySet must be of the same (or derived) EntityType. An EntitySet is conceptually similar to a database table, while an entity is similar to a row of a table. An entity instance must belong to exactly one entity set. In a similar fashion, relationship instances are logically contained within a RelationshipSet. The definition of a RelationshipSet scopes the relationship. That is, it identifies the EntitySets that hold instances of the entity types that participate in the relationship. A RelationshipSet is conceptually similar to a link-table in a database. SimpleTypes and ComplexTypes can only be instantiated as properties of an EntityType. An EntityContainer is a logical grouping of EntitySets and RelationshipSets—akin to how a Schema is a grouping mechanism for EDM types.

### An Example EDM Schema

A sample EDM schema is shown below:

```
<?xml version=“1.0” encoding=“utf-8”?>
<Schema Namespace=“AdventureWorks” Alias=“Self” ...>
  <EntityContainer Name=“AdventureWorksContainer”>
    <EntitySet Name=“ESalesOrders”
            EntityType=“Self.ESalesOrder” />
    <EntitySet Name=“ESalesPersons”
            EntityType=“Self.ESalesPerson” />
    <AssociationSet Name=“ESalesPersonOrders”
          Association=“Self.ESalesPersonOrder”>
      <End Role=“ESalesPerson”
          EntitySet=“ESalesPersons” />
      <End Role=“EOrder” EntitySet=“ESalesOrders” />
    </AssociationSet>
  </EntityContainer>
  <!-- Sales Order Type Hierarchy-->
  <EntityType Name=“ESalesOrder” Key=“Id”>
    <Property Name=“Id” Type=“Int32”
            Nullable=“false” />
    <Property Name=“AccountNum” Type=“String”
            MaxLength=“15” />
  </EntityType>
  <EntityType Name=“EStoreSalesOrder”
            BaseType=“Self.ESalesOrder”>
    <Property Name=“Tax” Type=“Decimal”
            Precision=“28” Scale=“4” />
  </EntityType>
  <!-- Person EntityType -->
  <EntityType Name=“ESalesPerson” Key=“Id”>
    <!-- Properties from SSalesPersons table-->
    <Property Name=“Id” Type=“Int32”
            Nullable=“false” />
    <Property Name=“Bonus” Type=“Decimal”
            Precision=“28” Scale=“4” />
    <!-- Properties from SEmployees table-->
    <Property Name=“Title” Type=“String”
            MaxLength=“50” />
    <Property Name=“HireDate” Type=“DateTime” />
    <!-- Properties from the SContacts table-->
    <Property Name=“Name” Type=“String”
            MaxLength=“50” />
    <Property Name=“Contact” Type=“Self.ContactInfo”
            Nullable=“false” />
  </EntityType>
  <ComplexType Name=“ContactInfo”>
    <Property Name=“Email” Type=“String”
            MaxLength=“50” />
    <Property Name=“Phone” Type=“String”
            MaxLength=“25” />
  </ComplexType>
  <Association Name=“ESalesPersonOrder”>
    <End Role=“EOrder” Type=“Self.ESalesOrder”
        Multiplicity=“*” />
    <End Role=“ESalesPerson” Multiplicity=“1”
        Type=“Self.ESalesPerson” />
  </Association>
</Schema>
```

3.3 High-Level Architecture

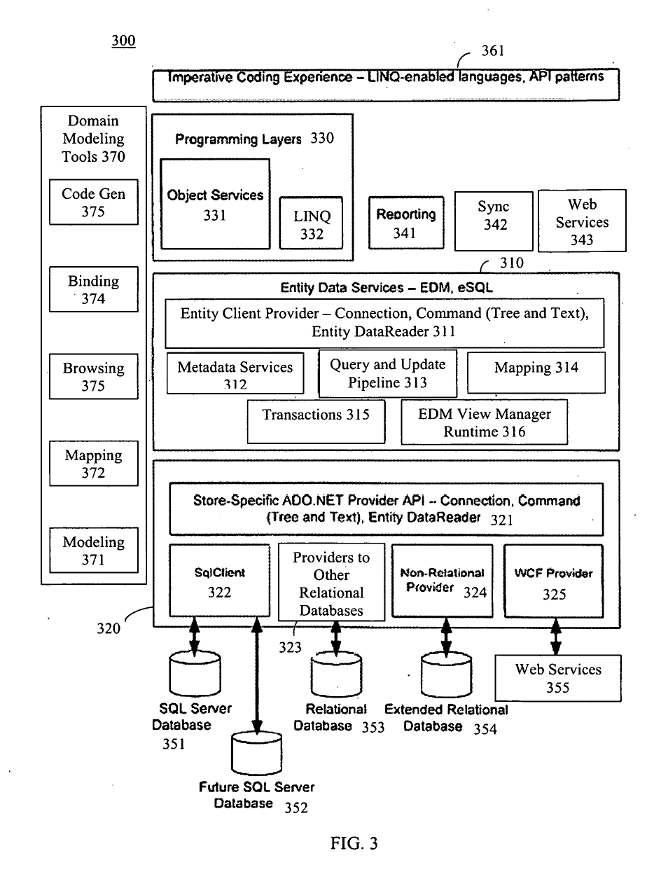

This section outlines the architecture of the ADO.NET Entity Framework. Its main functional components are illustrated in FIG. 3 and comprise the following:

Data source-specific providers. FIG. 3 shows a block diagram of an Entity Framework 300. Entity Framework 300 builds on the ADO.NET data provider model. There are specific providers 322-325 for several data sources such as SQL Server 351, 352, relational sources 353, non-relational 354, and Web services 355 sources. The providers 322-325 can be called from a store-specific ADO.NET Provider API 321.

EntityClient provider: The EntityClient provider 311 represents a concrete conceptual programming layer. It is a new, value-based data provider where data is accessed in terms of EDM entities and relationships and is queried/updated using an entity-based SQL language (Entity SQL). The EntityClient provider 311 forms part of an Entity Data Services 310 package that may also include metadata services 312, a query and update pipeline 313 (further illustrated in the section below entitled “Further Aspects and Embodiments”), transactions support 315, a view manager runtime 316, and a view mapping subsystem 314 that supports updatable EDM views over flat relational tables. The mapping between tables and entities is specified declaratively via a mapping specification language.

Object Services and other Programming Layers: The Object Services component 331 of the Entity Framework 300 provides a rich object abstraction over entities, a rich set of services over these objects, and allows applications to program in an imperative coding experience 361 using familiar programming language constructs. This component provides state management services for objects (including change tracking, identity resolution), supports services for navigating and loading objects and relationships, supports queries via LINQ and Entity SQL using components such as LINQ 332, and allows objects to be updated and persisted.

The Entity Framework allows multiple programming layers akin to 330 to be plugged onto the value-based entity data services layer 310 exposed by the EntityClient provider 311. The Object Services 330 component is one such programming layer that surfaces CLR objects, and provides ORM-like functionality.

The Metadata services 312 component manages metadata for the design time and runtime needs of the Entity Framework 300, and applications over the Entity Framework. All metadata associated with EDM concepts (entities, relationships, EntitySets, RelationshipSets), store concepts (tables, columns, constraints), and mapping concepts are exposed via metadata interfaces. The metadata component 312 also serves as a link between the domain modeling tools which support model-driven application design.

Design and Metadata Tools: The Entity Framework 300 integrates with domain designers 370 to enable model-driven application development. The tools include EDM design tools, modeling tools, 371, mapping design tools 372, browsing design tools 373, binding design tools 374, code generation tools 375, and query modelers.

Services: Rich data-centric services such as Reporting 341, Synchronization 342, Web Services 343 and Business Analysis can be built using the Entity Framework 300.

4. Programming Patterns

The ADO.NET Entity Framework together with LINQ increases application developer productivity by significantly reducing the impedance mismatch between application code and data. In this section we describe the evolution in data access programming patterns at the logical, conceptual and object abstraction layers.

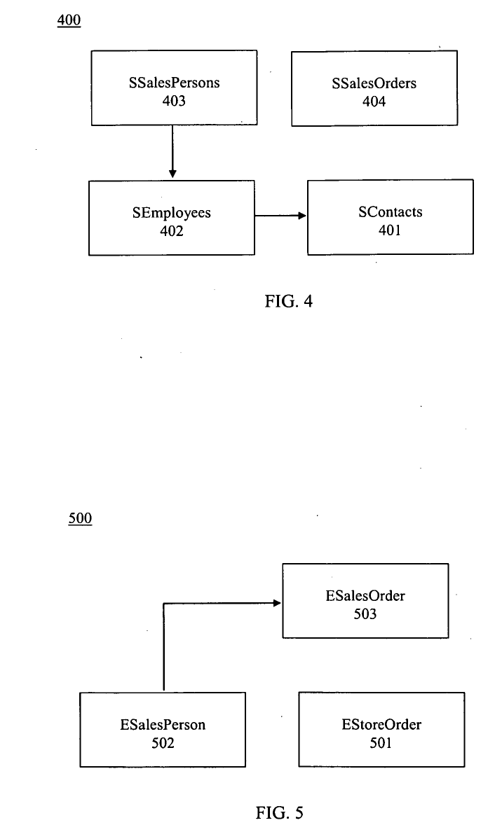

Consider the following relational schema fragment based on the sample AdventureWorks database. The relational schema fragment is shown in FIG. 4 as a relational schema 400. As shown in FIG. 4, relational schema 400 includes SContacts 401, SEmployees 402, SSalesPersons 403, and SSalesOrders 404, which may be tables having entries containing the information shown below and which may follow a relational schema such as that illustrated in FIG. 4.

SContacts (ContactId, Name, Email, Phone)

SEmployees (EmployeeId, Title, HireDate)

SSalesPersons (SalesPersonId, Bonus)

SSalesOrders (SalesOrderId, SalesPersonId)

Consider an application code fragment to obtain the name and hired date of salespeople who were hired prior to some date (shown below). There are four main shortcomings in this code fragment that have little to do with the business question that needs to be answered. First, even though the query can be stated in English very succinctly, the SQL statement is quite verbose and requires the developer to be aware of the normalized relational schema to formulate the multi-table join required to collect the appropriate columns from the SContacts, SEmployees, and SSalesPerson tables. Additionally, any change to the underlying database schemas will require corresponding changes in the code fragment below. Second, the user has to define an explicit connection to the data source. Third, since the results returned are not strongly typed, any reference to non-existing columns names will be caught only after the query has executed. Fourth, the SQL statement is a string property to the Command API and any errors in its formulation will be only caught at execution time. While this code is written using ADO.NET 2.0, the code pattern and its shortcomings applies to any other relational data access API such as ODBC, JDBC, or OLE-DB.

```
void EmpsByDate(DateTime date) {
using( SqlConnection con =
    new SqlConnection (CONN_STRING) ) {
  con.Open( );
  SqlCommand cmd = con.CreateCommand( );
  cmd.CommandText = @”
  SELECT SalesPersonID, FirstName, HireDate
  FROM SSalesPersons sp
      INNER JOIN SEmployees e
      ON sp.SalesPersonID = e.EmployeeID
    INNER JOIN SContacts c
    ON e.EmployeeID = c.ContactID
  WHERE e.HireDate < @date”;
  cmd.Parameters.AddWithValue(“@date”,date);
  DbDataReader r = cmd.ExecuteReader( );
  while(r.Read( )) {
      Console.WriteLine(“{0:d}:\t{1}”,
        r[“HireDate”], r[“FirstName”]);
} } }
```

The sample relational schema can be captured at the conceptual level via an EDM schema. For example, FIG. 5 shows a conceptual schema 500 that includes entity types ESalesOrder 503, ESalesPerson 502, and ESalesOrder 503. Conceptual schema 500 defines entity type ESalesPerson 502 that abstracts out the fragmentation of SContacts 401, SEmployees 402, and SSalesPersons 403 tables. It also captures the inheritance relationship between EStoreOrder 501 and ESalesOrder 503 entity types.

The equivalent program at the conceptual layer is written as follows:

```
void EmpsByDate (DateTime date) {
using( EntityConnection con =
  new EntityConnection (CONN_STRING) ) {
    con.Open( );
    EntityCommand cmd = con.CreateCommand( );
    cmd.CommandText = @”
      SELECT VALUE sp
      FROM ESalesPersons sp
      WHERE sp.HireDate < @date”;
    cmd.Parameters.AddWithValue (“date”,
        date);
        DbDataReader r = cmd.ExecuteReader(
              CommandBehavior.SequentialAccess);
    while (r.Read( )) {
          Console.WriteLine(“{0:d}:\t{1}”,
            r[“HireDate”]], r[“FirstName”])
} } }
```

The SQL statement has been considerably simplified-the user no longer has to know about the precise database layout. Furthermore, the application logic can be isolated from changes to the underlying database schema. However, this fragment is still string-based, still does not get the benefits of programming language type-checking, and returns weakly typed results.

By adding a thin object wrapper around entities and using the Language Integrated Query (LINQ) extensions in C#, one can rewrite the equivalent function with no impedance mismatch as follows:

```
void EmpsByDate(DateTime date) {
  using (AdventureWorksDB aw =
    new AdventureWorksDB( )) {
    var people = from p in aw.SalesPersons
          where p.HireDate < date
          select p;
    foreach (SalesPerson p in people) {
      Console.WriteLine(“{0:d}\t{1}”,
        p.HireDate, p.FirstName);
} } }
```

The query is simple; the application is (largely) isolated from changes to the underlying database schema; and the query is fully type-checked by the C# compiler. In addition to queries, one can interact with objects and perform regular Create, Read, Update and Delete (CRUD) operations on the objects. Examples of these are described in the Update Processing section.

5. Object Services

The Object Services component is a programming/presentation layer over the conceptual (entity) layer. It houses several components that facilitate the interaction between the programming language and the value-based conceptual layer entities. We expect one object service to exist per programming language runtime (e.g., .NET, Java). If it is designed to support the .NET CLR, programs in any .NET language can interact with the Entity Framework. Object Services is composed of the following major components:

The ObjectContext class houses the database connection, metadata workspace, object state manager, and object materializer. This class includes an object query interface ObjectQuery<T> to enable the formulation of queries in either Entity SQL or LINQ syntax, and returns strongly-typed object results as an ObjectCollection<T>. The ObjectContext also exposes query and update (i.e., SaveChanges) object-level interfaces between the programming language layer and the conceptual layer. The Object state manager has three main functions: (a) cache query results, providing identity resolution, and managing policies to merge objects from overlapping query results, (b) track in-memory changes, and (c) construct the change list input to the update processing infrastructure (see Sec. 8). The object state manager maintains the state of each entity in the cache—detached (from the cache), added, unchanged, modified, and deleted—and tracks their state transitions. The Object materializer performs the transformations during query and update between entity values from the conceptual layer and the corresponding CLR objects.

6. Mapping

The backbone of a general-purpose data access layer such as the ADO.NET Entity Framework is a mapping that establishes a relationship between the application data and the data stored in the database. An application queries and updates data at the object or conceptual level and these operations are translated to the store via the mapping. There are a number of technical challenges that have to be addressed by any mapping solution. It is relatively straightforward to build an ORM that uses a one-to-one mapping to expose each row in a relational table as an object, especially if no declarative data manipulation is required. However, as more complex mappings, set-based operations, performance, multi-DBMS-vendor support, and other requirements weigh in, ad hoc solutions quickly grow out of hand.

6.1 Problem: Updates via Mappings

The problem of accessing data via mappings can be modeled in terms of “views”, i.e., the objects/entities in the client layer can be considered as rich views over the table rows. However, it is well known that only a limited class of views is updateable, e.g., commercial database systems do not allow updates to multiple tables in views containing joins or unions. Finding a unique update translation over even quite simple views is rarely possible due to the intrinsic under-specification of the update behavior by a view. Research has shown that teasing out the update semantics from views is hard and can require significant user expertise. However, for mapping-driven data access, it is advantageous that there exists a well-defined translation of every update to the view.

Furthermore, in mapping-driven scenarios, the updatability requirement goes beyond a single view. For example, a business application that manipulates Customer and Order entities effectively performs operations against two views. Sometimes a consistent application state can only be achieved by updating several views simultaneously. Case-by-case translation of such updates may yield a combinatorial explosion of the update logic. Delegating its implementation to application developers is unsatisfactory because it requires them to manually tackle one of the most complicated parts of data access.

6.2 The ADO.NET Mapping Approach

The ADO.NET Entity Framework supports an innovative mapping architecture that aims to address the above challenges. It exploits the following ideas:

1. Specification: Mappings are specified using a declarative language that has well-defined semantics and puts a wide range of mapping scenarios within reach of non-expert users.

2. Compilation: Mappings are compiled into bidirectional views, called query and update views, that drive query and update processing in the runtime engine.

3. Execution: Update translation is done using a general mechanism that leverages materialized view maintenance, a robust database technology. Query translation uses view unfolding.

The new mapping architecture enables building a powerful stack of mapping-driven technologies in a principled, future-proof way. Moreover, it opens up interesting research directions of immediate practical relevance. The following subsections illustrate the specification and compilation of mappings. Execution is considered in the Query Processing and Update Processing sections, below.

6.3 Specification of Mappings

A mapping is specified using a set of mapping fragments. Each mapping fragment is a constraint of the form QEntities=QTables where QEntities is a query over the entity schema (on the application side) and QTables is a query over the database schema (on the store side). A mapping fragment describes how a portion of entity data corresponds to a portion of relational data. That is, a mapping fragment is an elementary unit of specification that can be understood independently of other fragments.

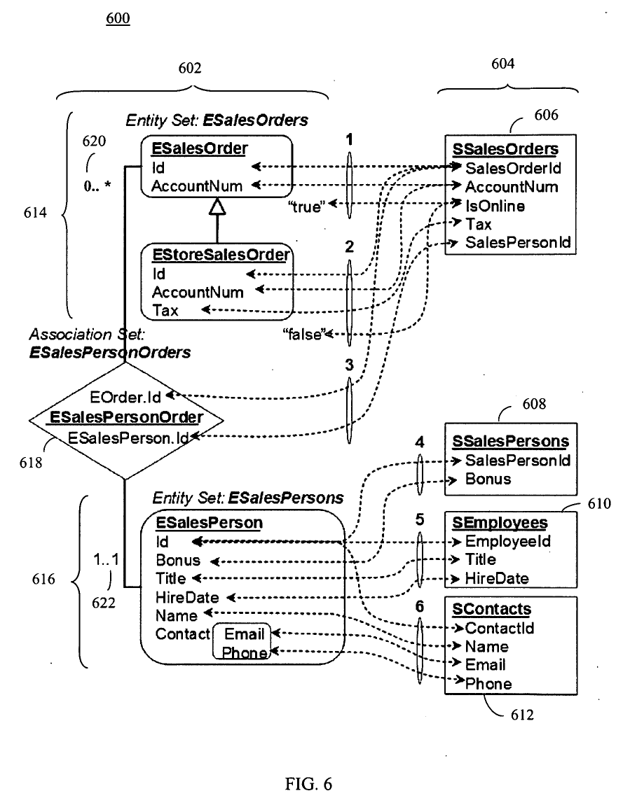

To illustrate, an example mapping scenario in FIG. 6. FIG. 6 shows a block diagram view of a mapping 600 between an entity schema 602 and a database (relational) schema 604. Mapping 600 can be defined using an XML file or a graphical tool, for example. Entity schema 602 corresponds to the entity schema referred to in the Entity Data Model section herein. As shown in FIG. 6, entity schema 602 includes an ESalesOrders entity set 614, an ESalesPersons entity set 616, and an ESalesPersonOrders association (relationship) set 618. ESalesOrders entity set 614 includes an ESalesOrder entity and an EStoreSalesOrder entity. ESalesPersons entity set 616 includes an ESalesPerson entity. ESalesPersonOrders association set 618 defines a relationship between the ESalesOrder entity and the ESalesPerson entity. Database schema 604 includes four tables, SSalesOrders 606, SSalesPersons 608, SEmployees 610, and SContacts 612.

In a mapping, such as mapping 600, one or more of an “arity” may be defined for each relationship. An arity indicates how many entities may be present in a particular portion of the relationship. For example, a first arity 620 and a second arity 622 are indicated in FIG. 6 for association set 618. First arity 620 indicates how many of the ESalesOrder entity may be present for each ESalesPerson entity, and second arity 622 indicates how many of the ESalesPerson entity may be present for each ESalesOrder entity. In the example of FIG. 6, first arity 620 is shown in FIG. 6 as “0 . . . *”, and indicates that every ESalesPerson may have any number of related ESalesOrders. Second arity 622 is shown in FIG. 6 as “1 . . . 1”, and indicates that every ESalesOrder must have one related ESalesPerson.

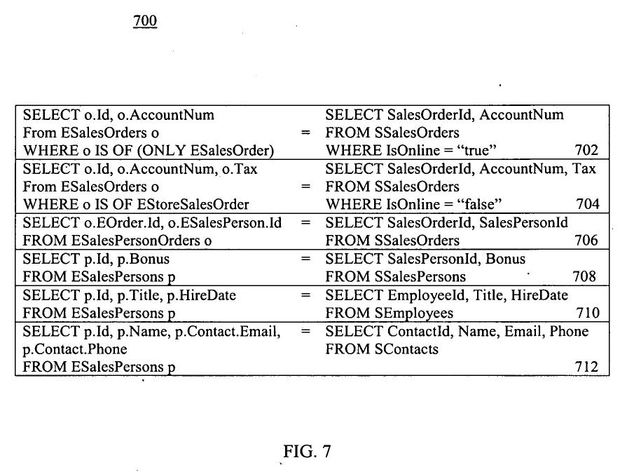

FIG. 7 shows a mapping 700 represented in terms of queries on entity schema 602 and database schema 604 of FIG. 6. As shown in FIG. 7, mapping 700 includes code fragments 702, 704, 706, 708, 710, and 712.

In FIG. 7, Fragment 702 indicates that the set of (Id, AccountNum) values for all entities of exact type ESalesOrder in ESalesOrders is identical to the set of (SalesOrderld, AccountNum) values retrieved from the SSalesOrders table for which IsOnline is true. Fragment 704 is similar. Fragment 706 maps the association set ESalesPersonOrders to the SSalesOrders table and indicates that each association entry corresponds to the primary key, foreign key pair for each row in this table. Fragments 708, 710, and 712 indicate that the entities in the ESalesPersons entity set are split across three tables SSalesPersons, SContacts, SEmployees.

6.4 Bidirectional Views

The mappings are compiled into bidirectional Entity SQL views that drive the runtime. The query views express entities in terms of tables, while the update views express tables in terms of entities.

Update views may be somewhat counterintuitive because they specify persistent data in terms of virtual constructs, but as we show later, they can be leveraged for supporting updates in an elegant way. The generated views ‘respect’ the mapping in a well-defined sense and have the following properties (note that the presentation is slightly simplified—in particular, the persistent state is not completely determined by the virtual state):

Entities=QueryViews(Tables)

Tables=UpdateViews(Entities)

Entities=QueryViews(UpdateViews(Entities))

The last condition is the roundtripping criterion, which ensures that all entity data can be persisted and reassembled from the database in a lossless fashion. The mapping compiler included in the Entity Framework guarantees that the generated views satisfy the roundtripping criterion. It raises an error if no such views can be produced from the input mapping.

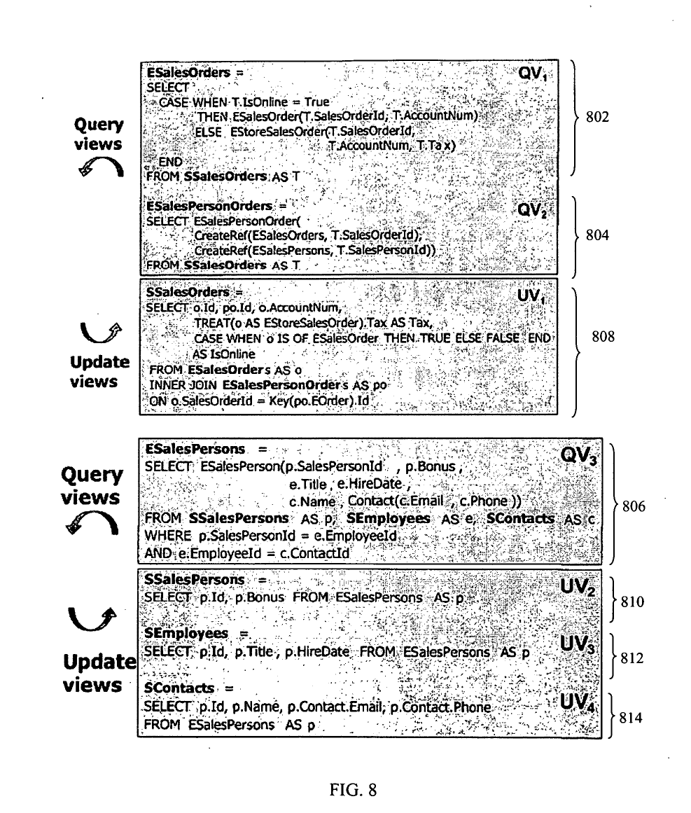

FIG. 8 shows query views (query views 802, 804, and 806) and update views (update views 808, 810, 812, and 814) that are bidirectional views generated by a mapping compiler for mapping 700 in FIG. 7. In general, the views are significantly more complex than the input mapping, as they explicitly specify the required data transformations. For example, in QV₁ the ESalesOrders entity set is constructed from the SSalesOrders table so that either an ESalesOrder or an EStoreSalesOrder is instantiated depending on whether or not the IsOnline flag is true. To reassemble the ESalesPersons entity set from the relational tables, one needs to perform a join between SSalesPersons, SEmployees, and SContacts tables (QV₃).

Writing query and update views by hand that satisfy the roundtripping criterion is tricky and requires significant database expertise; therefore, present embodiments of the Entity Framework only accept the views produced by the built-in mapping compiler, although accepting views produced by other compilers or by hand is certainly plausible in alternative embodiments.

6.5 Mapping Compiler

The Entity Framework contains a mapping compiler that generates the query and update views from the EDM schema, the store schema, and the mapping (the metadata artifacts are discussed in the Metadata section herein). These views are consumed by the query and update pipelines. The compiler can be invoked either at design time or at runtime when the first query is executed against the EDM schema. The view generation algorithms used in the compiler are based on the answering-queries-using-views techniques for exact rewritings.

7. Query Processing

7.1 Query Languages

The Entity Framework is designed to work with multiple query languages. We describe Entity SQL and LINQ embodiments in more detail herein, understanding that the same or similar principles can be extended to other embodiments.

### Entity SQL

Entity SQL is a derivative of SQL designed to query and manipulate EDM instances. Entity SQL extends standard SQL in the following ways.

1. Native support for EDM constructs (entities, relationships, complex types etc.): constructors, member accessors, type interrogation, relationship navigation, nest/unnest etc.

2. Namespaces: Entity SQL uses namespaces as a grouping construct for types and functions (similar to XQuery and other programming languages).

3. Extensible functions: Entity SQL supports no built-in functions. All functions (min, max, substring, etc.) are defined externally in a namespace, and imported into a query, usually from the underlying store.

4. More orthogonal treatment of sub-queries and other constructs as compared to SQL.

The Entity Framework supports Entity SQL as the query language at the EntityClient provider layer, and in the Object Services component. A sample Entity SQL query is shown in the Programming Patterns section herein.

### Language Integrated Query (LINQ)

Language-integrated query, or LINQ, is an innovation in .NET programming languages that introduces query-related constructs to mainstream programming languages such as C# and Visual Basic. The query expressions are not processed by an external tool or language pre-processor but instead are first-class expressions of the languages themselves. LINQ allows query expressions to benefit from the rich metadata, compile-time syntax checking, static typing and IntelliSense that was previously available only to imperative code. LINQ defines a set of general-purpose standard query operators that allow traversal, filter, join, projection, sorting and grouping operations to be expressed in a direct yet declarative way in any .NET-based programming language. .NET Languages such as Visual Basic and C# also support query comprehensions—language syntax extensions that leverage the standard query operators. An example query using LINQ in C# is shown in the Programming Patterns section herein.

7.2 Canonical Command Trees

Canonical Command Trees—more simply, command trees-are the programmatic (tree) representation of all queries in the Entity Framework. Queries expressed via Entity SQL or LINQ are first parsed and converted into command trees; all subsequent processing is performed on the command trees. The Entity Framework also allows queries to be dynamically constructed (or edited) via command tree construction/edit APIs. Command trees may represent queries, inserts, updates, deletes, and procedure calls. A command tree is composed of one or more Expressions. An Expression simply represents some computation—the Entity Framework provides a variety of expressions including constants, parameters, arithmetic operations, relational operations (projection, filter, joins etc.), function calls and so on. Finally, command trees are used as the means of communication for queries between the EntityClient provider and the underlying store-specific provider.

7.3 Query Pipeline

Query execution in the Entity Framework is delegated to the data stores. The query processing infrastructure of the Entity Framework is responsible for breaking down an Entity SQL or LINQ query into one or more elementary, relational-only queries that can be evaluated by the underlying store, along with additional assembly information, which is used to reshape the flat results of the simpler queries into the richer EDM structures.

The Entity Framework assumes that stores must support capabilities similar to that of SQL Server 2000. Queries are broken down into simpler flat-relational queries that fit this profile. Alternative embodiments of the Entity Framework may allow stores to take on larger parts of query processing.

A Typical Query is Processed as Follows:

Syntax and Semantic Analysis: An Entity SQL query is first parsed and semantically analyzed using information from the Metadata services component. LINQ queries are parsed and analyzed as part of the appropriate language compiler.

Conversion to a Canonical Command Tree: The query is now converted into a command tree, regardless of how it was originally expressed, and validated.

Mapping View Unfolding: Queries in the Entity Framework target the conceptual (EDM) schemas. These queries must be translated to reference the underlying database tables and views instead. This process—referred to as mapping view unfolding—is analogous to the view unfolding mechanism in database systems. The mappings between the EDM schema and the database schema are compiled into query and update views. The query view is then unfolded in the user query—the query now targets the database tables and views.

Structured Type Elimination: All references to structured types are now eliminated from the query, and added to the reassembly information (to guide result assembly). This includes references to type constructors, member accessors, type interrogation expressions.

Projection Pruning: The query is analyzed, and unreferenced expressions in the query are eliminated.

Nest Pull-up: Any nesting operations (constructing nested collections) in the query are pushed up to the root of the query tree over a sub-tree containing only flat relational operators. Typically, the nesting operation is transformed into a left outer join (or an outer apply), and the flat results from the ensuing query are then reassembled (see Result Assembly below) into the appropriate results.

Transformations: A set of heuristic transformations are applied to simplify the query. These include filter pushdowns, apply to join conversions, case expression folding, etc. Redundant joins (self-joins, primary-key, foreign-key joins) are eliminated at this stage. Note that the query processing infrastructure here does not perform any cost-based optimization.

Translation into Provider-Specific Commands: The query (i.e., command tree) is now handed off to providers to produce a provider-specific command, possibly in the providers' native SQL dialect. We refer to this step as SQLGen.

Execution: The provider commands are executed.

Result Assembly: The results (DataReaders) from the providers are then reshaped into the appropriate form using the assembly information gathered earlier, and a single DataReader is returned to the caller.

Materialization: For queries issued via the Object Services component, the results are then materialized into the appropriate programming language objects.

7.4 SQLGen

As mentioned in the previous section, query execution may be delegated to the underlying store. The query must first be translated into a form that is appropriate for the store. However, different stores support different dialects of SQL, and it is infeasible for the Entity Framework to natively support all of them. The query pipeline hands over a query in the form of a command tree to the store provider. The store provider must translate the command tree into a native command. This is usually accomplished by translating the command tree into the provider's native SQL dialect—hence the term SQLGen for this phase. The resulting command can then be executed to produce the relevant results. In addition to working against various versions of SQL Server, the Entity Framework may be integrated with various third-party ADO.NET providers for DB2, Oracle, and MySQL, and so forth.

8. Update Processing

This section describes how update processing is performed in the ADO.NET Entity Framework. There are two phases to update processing, compile time and runtime.

In the Bidirectional Views section provided herein, we described the process of compiling the mapping specification into a collection of view expressions. This section describes how these view expressions are exploited at runtime to translate the object modifications performed at the object layer (or Entity SQL DML updates at the EDM layer) into equivalent SQL updates at the relational layer.

8.1 Updates via View Maintenance

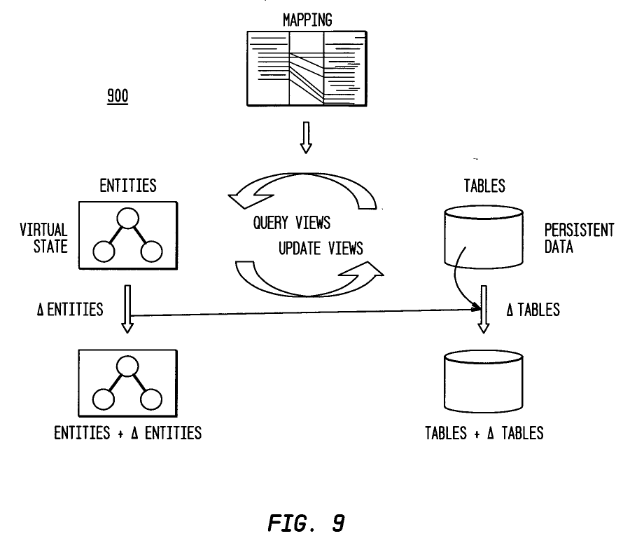

One of the insights exploited in the ADO.NET mapping architecture is that materialized view maintenance algorithms can be leveraged to propagate updates through bidirectional views. FIG. 9 shows a system 900 representing view maintenance techniques used to propagate updates between entities and tables.

Tables inside a database, as illustrated on the right hand side of FIG. 9, hold persistent data. An EntityContainer, as illustrated on the left side of FIG. 9, represents a virtual state of this persistent data since typically only a tiny fraction of the entities in the EntitySets are materialized on the client. The goal is to translate an update AEntities on the state of Entities into an update ΔTables on the persistent state of Tables. This process is referred to as incremental view maintenance, because the update is performed based on an update AEntities representing the changed aspects of an entity.

This can be done using the following two steps:

1. View Maintenance:

ΔTables=ΔUpdateViews(Entities, ΔEntities)

2. View Unfolding:

ΔTables=ΔUpdateViews (QueryViews(Tables), ΔEntities)

In Step 1, view maintenance algorithms are applied to update views. This produces a set of delta expressions, ΔUpdateViews, which tell us how to obtain ΔTables from ΔEntities and a snapshot of Entities. Since the latter is not fully materialized on the client, in Step 2 view unfolding is used to combine the delta expressions with query views. Together, these steps generate an expression that takes as input the initial database state and the update to entities, and computes the update to the database.

This approach yields a clean, uniform algorithm that works for both object-at-a-time and set-based updates (i.e., those expressed using data manipulation statements), and leverages robust database technology. In practice, Step 1 is often sufficient for update translation since many updates do not directly depend on the current database state; in those situations we have ΔTables=ΔUpdateViews(ΔEntities). If ΔEntities is given as a set of object-at-a-time modifications on cached entities, then Step 1 can be further optimized by executing view maintenance algorithms directly on the modified entities rather than computing the ΔUpdateViews expression.

8.2 Translating Updates on Objects

To illustrate the approach outlined above, consider the following example which gives a bonus and promotion to eligible salespeople who have been with the company for at least 5 years.

```
using(AdventureWorksDB aw =
    new AdventureWorksDB(...)) {
  // People hired at least 5 years ago
  Datetime d = DateTime.Today.AddYears(−5);
  var people = from p in aw.SalesPeople
        where p.HireDate < d
        select p;
  foreach(SalesPerson p in people) {
    if (HRWebService.ReadyForPromotion(p)) {
      p.Bonus += 10;
      p.Title = “Senior Sales Representative”;
    }
  }
  aw.SaveChanges( ); // push changes to DB
}
```

AdventureWorksDB is a tool-generated class that derives from a generic object services class, called ObjectContext, which houses the database connection, metadata workspace, and object cache data structure, and exposes the SaveChanges method. As we explained in the Object Services section, the object cache maintains a list of entities, each of which is in one of the following states: detached (from the cache), added, unchanged, modified, and deleted. The above code fragment describes an update that modifies the title and bonus properties of ESalesPerson objects which are stored in the SEmployees and SSalesPersons tables, respectively. The process of transforming the object updates into the corresponding table updates triggered by the call to the SaveChanges method may comprise the following four steps:

Change List Generation: A list of changes per entity set is created from the object cache. Updates are represented as lists of deleted and inserted elements. Added objects become inserts. Deleted objects become deletes.

Value Expression Propagation: This step takes the list of changes and the update views (kept in the metadata workspace) and, using incremental materialized view maintenance expressions AUpdateViews, transforms the list of object changes into a sequence of algebraic base table insert and delete expressions against the underlying affected tables. For this example, the relevant update views are UV₂ and UV₃ shown in FIG. 8. These views are simple project-select queries, so applying view maintenance rules is straightforward. We obtain the following ΔUpdateViews expressions, which are the same for insertions (Δ⁺) and deletions (Δ⁻):

```
ΔSSalesPersons = SELECT p.Id, p.Bonus
    FROM ΔESalesPersons AS p
ΔSEmployees = SELECT p.Id, p.Title
    FROM ΔESalesPersons AS p
ΔSContacts = SELECT p.Id, p.Name, p.Contact.Email,
    p.Contact.Phone FROM ΔESalesPersons AS p
```

Suppose the loop shown above updated the entity E_{old}=ESalesPersons(1, 20, “ ”, “Alice”, Contact(“a@sales”, NULL)) to E_{new}=ESalesPersons(1, 30, “Senior . . . ”, “Alice”, Contact(“a@sales”, NULL)). Then, the initial delta is Δ⁺ESalesOrders={E_{new}} for insertions and Δ⁻ESalesOrders={E_{old}} for deletions. We obtain Δ⁺SSalesPersons={(1, 30)}, Δ⁻SSalesPersons={(1, 20)}. The computed insertions and deletions on the SSalesPersons table are then combined into a single update that sets the Bonus value to 30. The deltas on SEmployees are computed analogously. For SContacts, we get Δ⁺SContacts=Δ⁻SContacts, so no update is required.

In addition to computing the deltas on the affected base tables, this phase is responsible for (a) the correct ordering in which the table updates must be performed, taking into consideration referential integrity constraints, (b) retrieval of store-generated keys needed prior to committing updates to the database, and (c) gathering the information for optimistic concurrency control.

SQL DML or Stored Procedure Calls Generation: This step transforms the list of inserted and deleted deltas plus additional annotations related to concurrency handling into a sequence of SQL DML statements or stored procedure calls. In this example, the update statements generated for the affected salesperson are:

BEGIN TRANSACTION
UPDATE [dbo].[SSalesPersons] SET [Bonus]=30
WHERE [SalesPersonID]=1
UPDATE [dbo].[SEmployees]
SET [Title]= N‘Senior Sales Representative’
WHERE [EmployeeID]=1
COMMIT TRANSACTION

Cache Synchronization: Once updates have been performed, the state of the cache is synchronized with the new state of the database. Thus, if necessary, a mini-query-processing step is performed to transform the new modified relational state to its corresponding entity and object state.

9. Metadata

The metadata subsystem is analogous to a database catalog, and is designed to satisfy the design-time and runtime metadata needs of the Entity Framework.

9.1 Metadata Artifacts

Metadata Artifacts May Include the Following:

Conceptual Schema (CSDL files): The conceptual schema is usually defined in a CSDL file (Conceptual Schema Definition Language) and contains the EDM types (entity types, relationships) and entity sets that describes the application's conceptual view of the data.

Store Schema (SSDL files): The store schema information (tables, columns, keys etc.) are expressed using CSDL vocabulary terms. For example, EntitySets denote tables, and properties denote columns. Usually, these are defined in an SSDL (Store Schema Definition Language) file.

C-S Mapping Specification (MSL file): The mapping between the conceptual schema and the store schema is captured in a mapping specification, typically in an MSL file (Mapping Specification Language). This specification is used by the mapping compiler to produce the query and update views.

Provider Manifest: The Provider Manifest is a description of functionality supported by each provider, and includes information about:

1. The primitive types (varchar, int, etc.) supported by the provider, and the EDM types (string, int32, etc.) they correspond to.

2. The built-in functions (and their signatures) for the provider.

This information is used by the Entity SQL parser as part of query analysis. In addition to these artifacts, the metadata subsystem also keeps track of the generated object classes, and the mappings between these and the corresponding conceptual entity types.

9.2 Metadata Services Architecture

The metadata consumed by the Entity Framework comes from different sources in different formats. The metadata subsystem is built over a set of unified low-level metadata interfaces that allow the metadata runtime to work independently of the details of the different metadata persistent formats/sources.

The metadata services include:
Enumeration of different types of metadata,
Metadata search by key,
Metadata browsing/navigation,
Creation of transient metadata (e.g., for query processing), and
Session independent metadata caching and reusing.

The metadata subsystem includes the following components. The metadata cache caches metadata retrieved from different sources, and provides consumers a common API to retrieve and manipulate the metadata. Since the metadata may be represented in different forms, and stored in different locations, the metadata subsystem supports a loader interface. Metadata loaders implement the loader interface, and are responsible for loading the metadata from the appropriate source (CSDL/SSDL files etc.). A metadata workspace aggregates several pieces of metadata to provide the complete set of metadata for an application. A metadata workspace usually contains information about the conceptual model, the store schema, the object classes, and the mappings between these constructs.

10. Tools

The Entity Framework may include a collection of design-time tools to increase development productivity.

Model designer: One of the early steps in the development of an application is the definition of a conceptual model. The Entity Framework allows application designers and analysts to describe the main concepts of their application in terms of entities and relationships. The model designer is a tool that allows this conceptual modeling task to be performed interactively. The artifacts of the design are captured directly in the Metadata component which may persist its state in the database. The model designer can also generate and consume model descriptions (specified via CSDL), and can synthesize EDM models from relational metadata.

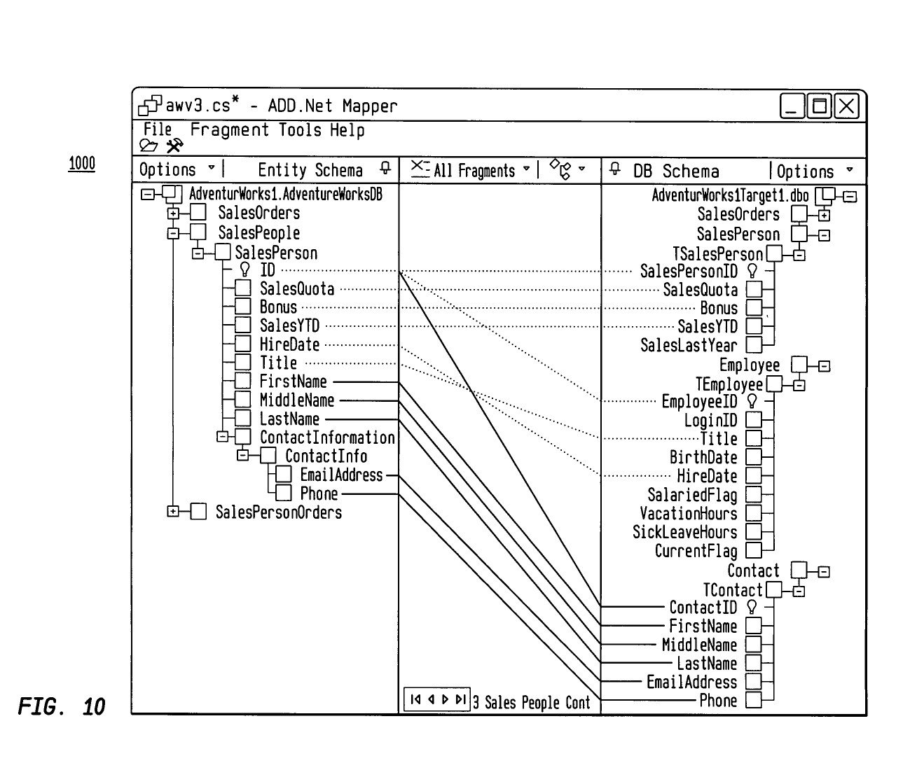

Mapping designer: Once an EDM model has been designed, the developer may specify how a conceptual model maps to a relational database. This task is facilitated by the mapping designer, which may present a user interface 1000 as illustrated in FIG. 10. The mapping designer helps developers describe how entities and relationships in an entity schema presented on the left hand side of user interface 1000 map to tables and columns in the database, as reflected in a database schema presented on the right side of user interface 1000 in FIG. 10. The links in the graph presented in the middle section of FIG. 10 visualize the mapping expressions specified declaratively as equalities of Entity SQL queries. These expressions become the input to the bidirectional mapping compilation component which generates the query and update views.

Code generation: The EDM conceptual model is sufficient for many applications as it provides a familiar interaction model based on ADO.NET code patterns (commands, connections, data readers). However, many applications prefer to interact with data as strongly-typed objects. The Entity Framework includes a set of code generation tools that take EDM models as input and produce strongly-typed CLR classes for entity types. The code generation tools can also generate a strongly-typed object context (e.g., AdventureWorksDB) which exposes strongly typed collections for all entity and relationship sets defined by the model (e.g., ObjectQuery<SalesPerson>).

### III. Example Object Relational Mapper

ORM 104 shown in FIG. 1 may be configured in various ways. As described above, in some embodiments, ORM 104 may include a “compile-time” portion and a “runtime portion.” The compile-time portion of ORM 104 may be used to compile mappings defined for applications into one or more mapping views (e.g., such as the mappings described above in sections II.A.6.2 and II.A.6.3). The runtime portion of ORM 104 performs mappings of application-level data modification commands to store-level data modification commands based on the mapping views.

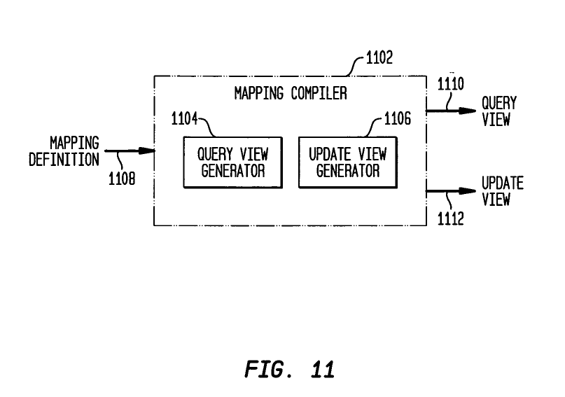

For example, FIG. 11 shows a block diagram of an example mapping compiler 1102 that may be included in ORM 104. Mapping compiler 1102 is an example compile-time portion of ORM 104. As shown in FIG. 11, mapping compiler 1102 receives a mapping definition 1108. Mapping definition 1108 may be generated by a user using a programming language (e.g., XML) or a graphical interface tool. For example, mapping definition 1108 may be a mapping defined as described above in section II.A.6.3. Mapping compiler 1102 is configured to compile one or more mappings received in mapping definition 1108 to generate one or more mapping views that may be used during runtime of ORM 104.

Mapping compiler 1102 may include one or both of a query view generator 1104 and an update view generator 1106. Query view generator 1104 is configured to generate a query view 1110 from the received mapping definition 1108. Query view 1110 includes one or more query views that express one or more entities defined in mapping definition 1108 in terms of one or more data tables defined in mapping definition 1108. Update view generator 1106 may be present in some embodiments of ORM 104 where bidirectional views are enabled. Update view generator 1106 is configured to generate an update view 1112 from the received mapping definition 1108. Update view 1112 includes one or more update views that express one or more of the data tables in terms of one or more of the entities. Query view 1110 and update view 1112 may be configured in various ways, such as in the form of SQL (structured query language) or other suitable language or form. Examples of query view 1110 and update view 1112 are shown in FIG. 8 and described above.

Mapping compiler 1102, including query view generator 1104 and/or update view generator 1106, may be implemented in hardware, software, firmware, or any combination thereof.

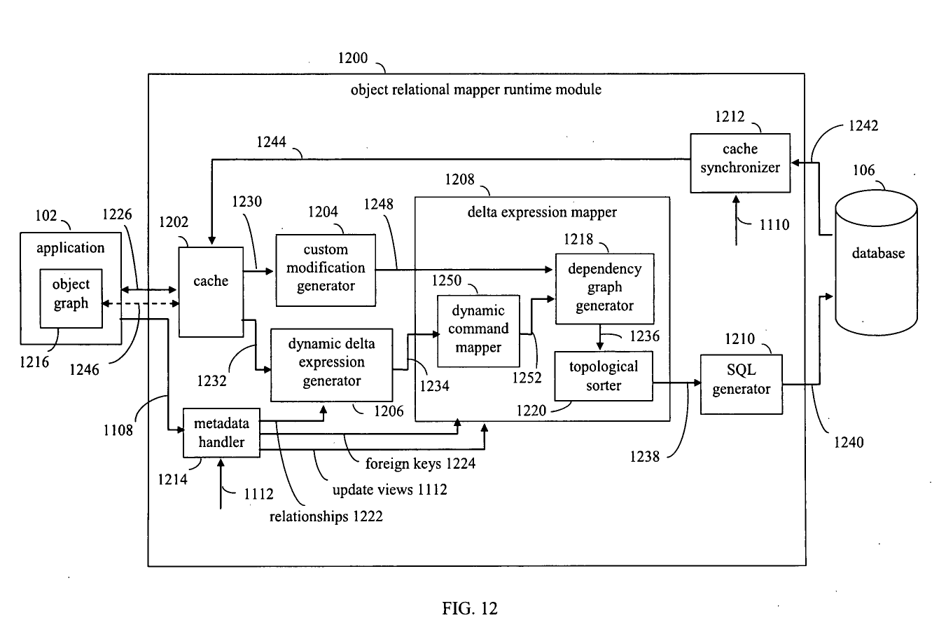

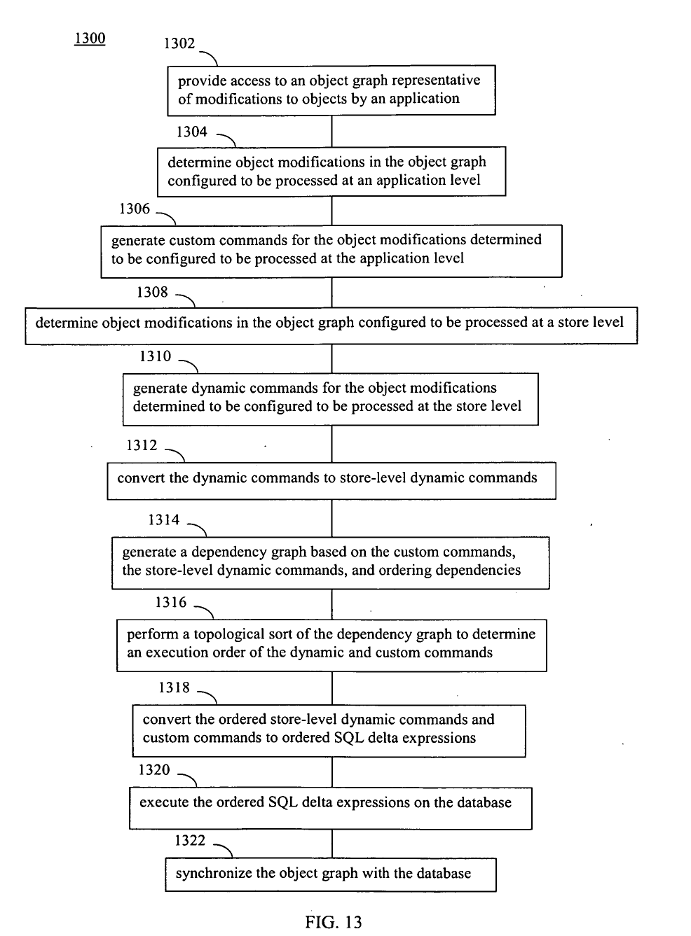

FIG. 12 shows a block diagram of an example ORM runtime update (or “write”) portion 1200 that may be included in ORM 104. As shown in FIG. 12, ORM runtime update portion 1200 includes a cache 1202, a custom modification generator 1204, a dynamic delta expression generator 1206, a delta expression mapper 1208, an SQL generator 1210, a cache synchronizer 1212, and a metadata handler 1214. Delta expression mapper 1208 includes a dependency graph generator 1218, a topological sorter 1220, and a dynamic command mapper 1250. ORM runtime update portion 1200, including the elements shown in FIG. 12, may be implemented in hardware, software, firmware, or any combination thereof. ORM runtime update portion 1200 is described as follows with reference to a flowchart 1300 shown in FIG. 13. Flowchart 1300 provides a process for mapping application-level modification commands to store-level modification commands. For instance, flowchart 1300 may be performed by ORM runtime update portion 1200 shown in FIG. 12. Flowchart 1300 and ORM runtime update portion 1200 are described as follows.

Metadata handler 1214 receives update views 1112 (e.g., from mapping compiler 1102 shown in FIG. 11) and receives mapping definition 1108 from application 102. For example, at initiation of runtime or during runtime, application 102 may provide mapping definition 1108 and/or update views 1112 to metadata handler 1214 in the form of configuration information. Based on mapping definition 1108, metadata handler 1214 provides information, such as relationships 1222, and foreign keys 1224, to various elements of ORM runtime update module 1200. Relationships 1222 (also referred to as “model ordering”) are a form of ordering dependencies defined at the application/object level. Foreign keys 1224 are a form of store-level ordering dependencies that ensure that specified rows of data tables (in database 106) are modified (e.g., rows are inserted, rows are deleted, and/or rows are updated) in a particular predetermined order. Relationships and foreign keys are known to persons skilled in the relevant art(s).

Flowchart 1300 begins with step 1302. In step 1302, access to an object graph representative of modifications to objects by an application is provided. As shown in FIG. 12, application 102 maintains an object graph 1216. Object graph 1216 indicates objects being created (inserted), updated, and/or deleted by application 102. Object graph 1216 indicates these changes to objects in the form of change commands, such as one or more insert commands, delete commands, and/or update commands. Object graph 1216 indicates changes at the level of entities, relationships and first-order attributes therein. Object graph 1216 may include an indication of a state of each entity. A state of an entity indicates what if any update action is required. A list of example possible states for an entity is shown below:

Detached: no op (the entity is not associated with the cache),

Added: such entities generate an “insert” expression,

Unchanged: no op (we allow “passive” concurrency conflicts),

Modified: such entities generate both an insert and a delete expression, and

Deleted: such entities generate a “delete” expression.

Interactions between application 102 and ORM runtime update module 1200 occur over a communication link 1226. Such interactions may include object graph accesses/updates 1246 and providing of mapping information 1228, which are described in further detail below. In an embodiment, application 102 and ORM runtime update module 1200 may be located in a same computer system or in different computer systems. As such, communication link 1226 may be internal to a computer system, or may be a communications link between separate computer systems. For instance, communications link 1226 may include one or more wired and/or wireless links, and may include a network, such as a local area network (LAN), a wide area network (WAN), or a combination of networks, such as the Internet. Although not shown in FIGS. 1 and 12, ORM 104 may include an application programming interface (API) configured as an interface for access by one or more applications such as application 102.

Cache 1202 is configured as the interface between objects and value layer constructs (e.g., EDM constructs). Cache 1202 tracks the objects that have been created, updated and deleted by application 102 by accessing object graph 1216 (as indicated by arrow 1246). For example, application 102 may transmit an indication to cache 1202 that object graph 1216 includes object change commands that are ready for processing. Cache 1202 may receive a copy of object graph 1216 from application 102, or may access object graph 1216 at application 102.

For purposes of propagation, cache 1202 may be configured to generate lists of inserted and deleted elements for every extent in object graph 1216. An “extent” is defined herein as either or both of an entity set and a relationship set.

Referring back to FIG. 13, in step 1304, object modifications in the object graph configured to be processed at an application level are determined. For instance, custom modification generator 1204 accesses cache 1202 to receive change commands in object graph 1216 that are indicated as application-level commands. As shown in FIG. 12, custom modification generator 1204 receives application-level object change commands 1230 from cache 1202.

In step 1306, custom commands are generated for the object modifications determined to be configured to be processed at the application-level. Based on application-level object change commands 1230, custom modification generator 1204 is configured to generate one or more custom expresssions that describe modification requests corresponding to application-level object change commands 1230 for particular extents (entity sets and relationship sets). In an example configuration, custom modification generator 1204 may be configured to generate the custom commands at the EDM level. For instance, custom modification generator 1204 may generate the custom commands as canonical query tree (CQT) delta expressions. As shown in FIG. 12, custom modification generator 1204 generates custom commands 1248.

In step 1308, object modifications in the object graph configured to be processed at a store level are determined. For instance, dynamic delta expression generator 1206 accesses cache 1202 to receive change commands in object graph 1216 that are indicated to be handled at the store-level. As shown in FIG. 12, dynamic delta expression generator 1206 receives store-level object change commands 1232 from cache 1202.

In step 1310, dynamic commands are generated for the object modifications configured to be processed at the store level. Based on store-level object change commands 1232, dynamic delta expression generator 1206 is configured to generate one or more object-level delta expressions that describe modification requests for particular extents (entity sets and relationship sets). In an example configuration, dynamic delta expression generator 1206 may be configured to generate delta expressions at the EDM level. For instance, dynamic delta expression generator 1206 may generate the delta expressions as canonical query tree (CQT) delta expressions. As shown in FIG. 12, dynamic delta expression generator 1206 generates object level dynamic commands 1234.

Delta expression mapper 1208 is configured to map object-level expressions to store-level expressions. For example, in an embodiment, delta expression mapper 1208 may be configured to perform steps 1312, 1314, and 1316 of flowchart 1300. Delta expression mapper 1208 receives as input “update mapping views” from metadata handler 1214 and EDM level change requests from cache 1202. As described above, update views 1112 describe store tables (in database 106) with respect to entities (in object graph 1216). Update views 1112 enable delta expression mapper 1208 to treat the O-R problem as a special case of view maintenance.

In step 1312, the dynamic commands are converted to store-level dynamic commands. For example, dynamic command mapper 1250 receives dynamic commands 1234. Command mapper 1250 converts each dynamic command (object-level) of dynamic commands 1234 to one or more corresponding store-level dynamic commands. As shown in FIG. 12, dynamic command mapper 1250 generates store-level dynamic commands 1252.

In step 1314, a dependency graph is generated based on the custom commands, the store-level dynamic commands, and ordering dependencies. For instance, dependency graph generator 1218 may receive store-level dynamic commands 1252, custom commands 1248, update views 1112, and foreign keys 1224. Dependency graph generator 1218 may be configured to generate a dependency graph that includes each custom command and each store-level dynamic command as a corresponding node, and includes edges connected between nodes. Each edge is defined to have a direction from a first node to a second node (which may be represented by an arrow from the first node to the second node), where the command represented by the first node must be performed prior to the command represented by the second node. The edges are determined by store constraints and model dependencies. The store constraints and model dependencies constrain the order in which operations can be applied in database 106. For instance, an order detail is inserted into database 106 before an order given a foreign key constraint between the two associated tables. In another case, if key values are generated by database 106 (e.g., SQL server identity columns), the generated key is to be acquired before producing or modifying records related to the key through either associations or entity splitting. As shown in FIG. 12, dependency graph generator 1218 generates a dependency graph 1236.

In step 1316, a topological sort of the dependency graph is performed to determine an execution order of the dynamic and custom commands. For example, topological sorter 1220 may receive dependency graph 1236, and may be configured to perform a topological sort of dependency graph 1236. The topological sort of dependency graph 1236 generates an order of execution of the commands associated with the nodes of dependency graph 1236 based on the edges of dependency graph. Topological sorter 1220 may be configured to perform any suitable conventional or proprietary topological sort routine. Numerous topological sort routines are well known to persons skilled in the relevant art(s). As shown in FIG. 12, topological sorter 1220 generates ordered dynamic and custom commands 1238.

In step 1318, the ordered store-level dynamic command and custom commands are converted to ordered SQL delta expressions. For example, SQL generator 1210 may receive ordered dynamic and custom commands 1238. SQL generator 1210 may be configured to convert received store-level dynamic commands and custom commands to store-level delta expressions in the SQL language, where the ordering of the store-level delta expressions represents functional dependencies of the rows being modified. A delta expression is simply an expression (or query) describing rows to be inserted or deleted in a specific table of database 106. As shown in FIG. 12, SQL generator 1210 generates ordered SQL delta expressions 1240, which includes the generated store-level delta expressions in the order provided by ordered dynamic and custom commands 1238.

In step 1320, the ordered SQL delta expressions are executed on the database. For example, as shown in FIG. 12, database 106 receives ordered SQL delta expressions 1240. Database 106 executes the received SQL store-level delta expressions in ordered SQL delta expressions 1240, including inserting one or more rows, deleting one or more rows, and/or updating one or more rows of one or more tables of database 106. Database 106 executes the SQL store-level delta expressions in ordered SQL delta expressions 1240 in the order indicated by ordered SQL delta expressions 1240.

In step 1322, the object graph is synchronized with the database. After changes have been made to database 106 based on ordered SQL delta expressions 1240, cache 1202 and database 106 may be synchronized. As shown in FIG. 12, cache synchronizer 1212 receives store-level database-generated values 1242 from database 106. Store-level database-generated values 1242 may include one or more data values generated by database 106 that were stored in one or more data tables in database 106. Cache synchronizer 1212 converts store-level database-generated values 1242 to object-level database-generated values, which are output from cache synchronizer 1212 as object-level database-generated values 1244. For example, cache synchronizer 1212 may receive query views 1110 (e.g., generated by mapping compiler 1102 in FIG. 11) that are referenced to perform the conversion, so that the data values generated by database 106 are passed from store-level delta expressions to parent object-level delta expressions. As shown in FIG. 12, cache 1202 receives object-level database-generated values 1244. Cache 1202 may be configured to pass the object-level data values of object-level database-generated values 1244 to object graph 1216. For example, markup may be maintained, including back-pointers to the value for values propagated through the update, to allow reverse mapping of those values.

### IV. Example Embodiments

Embodiments for providing object relational mapping that enables the handing of dependencies between commands at different mapping layers and the interleaving of commands from these different mapping layers. In an embodiment, to model interactions between dynamic and custom commands, not only data is transformed while generating dynamic commands, but dependencies and constraints are also transformed. This provides a common interaction model for custom and dynamic operations.

The example embodiments described herein are provided for illustrative purposes, and are not limiting. Although some embodiments are described below in terms of the ADO.NET Entity Framework, such embodiments may be adapted to other object relational mapping systems. Furthermore, additional structural and operational embodiments, including modifications/alterations, will become apparent to persons skilled in the relevant art(s) from the teachings herein.

Combining dynamic and customized updates to data maintained in a database is challenging because dependencies between these operations can be difficult to describe. As described above, dynamic operations are actions on store objects (tables) while customized operations are actions on conceptual objects (entity sets and association sets). Some types of dependencies are interesting at both of the object and store levels, and some types are interesting only at one or the other level. Example dependencies are listed as follows:

Foreign key constraints (store-level ordering dependency): a foreign key constraint may be applied to a row of a data table, and are handled at the store-level (e.g., handled by database 106). Foreign key constraints ensure that rows are inserted/deleted/updated in a particular order. For example, a foreign key constraint assigned to a first table may indicate that a row of the first data table may be not be updated prior to a row of a designated second data table being updated.

Common values (store- and conceptual-level ordering dependency): a common value may be a value that is generated at the store-level or object-level during execution of a modification command. Through relationships or referential constraints, an object can imply the equality of two separate values (or equality across a chain of values). For instance, the key values of a relationship (also referred to as an “association” herein) are assumed to be equivalent to the key values of its ends (the indicated associated objects). When a value is generated and mapped to a store-generated column (or function result binding), that value must be propagated to other operations relying on the common value. As such, common values can imply an ordering dependency (e.g., the value cannot be propagated until it is generated).

Model ordering (conceptual-level ordering dependency) (also referred to as “relationships”): Model ordering is based on relationships defined at the object-level. With regared to customized updates (updates generated at the application level), the foreign key requirements of data tables in the database are not known. An entity at the application-level may be used as a proxy, and an assumption may be made that entities are pre-requisites for their relationships.

In embodiments, the common value and model ordering dependencies are enabled to be processed, providing a common interaction model for object-level and store-level modification operations.

In an embodiment, if two entity or association sets are mapped to a common data table, either both sets or neither set may use customized mapping. Where a customized mapping is specified, all relevant operations—delete, insert and update—must be mapped. This requirement allows us to focus on the problem of operation ordering.

In an embodiment, ordering dependencies may be processed as follows:

1. Foreign key constraints: as before, commands are treated as black boxes with respect to foreign key constraints. No dependencies between operations are introduced based on assumptions about where a foreign key constraint may exist.

2. Common value propagation: before generating any commands, internal ‘identifiers’ are assigned to all common values under consideration. An ancillary graph is generated that defining ‘ownership’ and ‘equivalencies’ across referential constraints. As a result, a value used in a dynamic operation can optionally have an identifier annotation that indicates how to interpret the dynamic operation relative to a user command.

3. Model ordering: a challenge with model ordering is to extract information about conceptual operations (at the entity and association set level) from store level operations (at the table level). This enables dynamic operations to be processed in much the same way as customized operations for the purposes of dependency ordering. Additional annotations on values allow us to recover its object or entity “donor.”

In an embodiment, a dynamic operation may be processed as follows to cause the dynamic operation appear as a conceptual operation:

1. For inserts, affected associations and entities are determined using the same process used in error propagation. For purposes of operation ordering, a store operation may be handled as a conceptual operation where each of the given entities or associations is being inserted.

2. Deletes are handled similarly to the handling of inserts.

3. Because of mapping restrictions, updates cannot influence an entity key, but can influence an association key. Where an association key value is changing, the operation is treated as a delete of one association (original values) and the insertion of another association (current values).

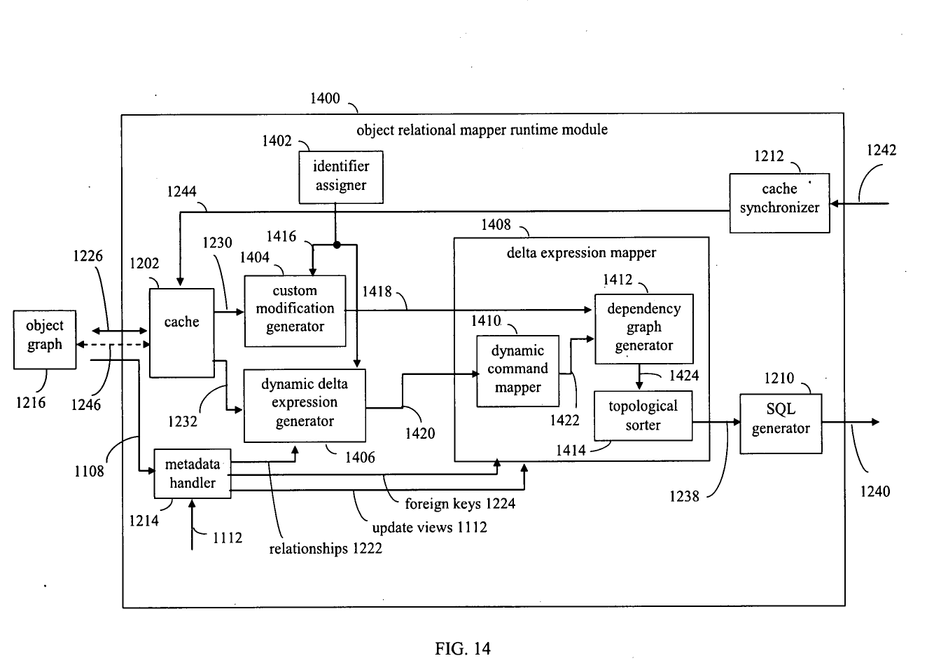

Example embodiments are described that are configured to process these dependencies across multiple mapping layers. For instance, FIG. 14 shows a block diagram of an example ORM runtime portion 1400 that may be included in ORM 104 (shown in FIG. 1), according to an embodiment. As shown in FIG. 12, ORM runtime update portion 1200 includes cache 1202, an identifier assigner 1402, a custom modification generator 1404, a dynamic delta expression generator 1406, a delta expression mapper 1408, SQL generator 1210, cache synchronizer 1212, and metadata handler 1214. Delta expression mapper 1408 includes a dynamic command mapper 1410, a dependency graph generator 1412, and a topological sorter 1414. ORM runtime portion 1400, including the elements shown in FIG. 14, may be implemented in hardware, software, firmware, or any combination thereof. ORM runtime portion 1400 is generally similar to ORM runtime update portion 1200 shown in FIG. 12, with differences described below. Note that application 102 and database 106 are not shown in FIG. 14 for ease of illustration.

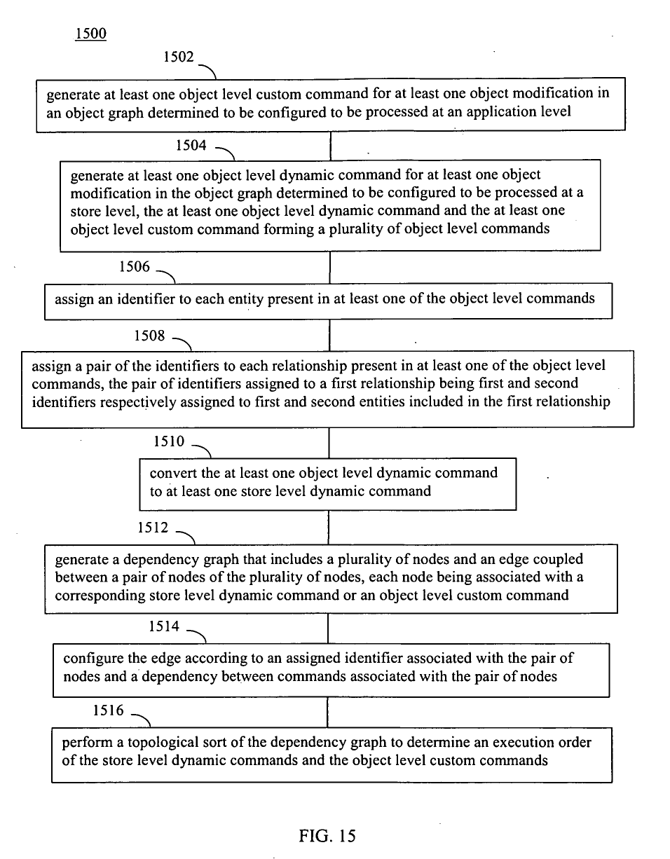

ORM runtime portion 1400 is described as follows with reference to a flowchart 1500 shown in FIG. 15. Flowchart 1500 provides a process for mapping application-level modification commands to store-level modification commands, according to an example embodiment. For instance, flowchart 1500 may be performed by ORM runtime portion 1400 shown in FIG. 14. Flowchart 1500 and ORM runtime portion 1400 are described as follows.

Note that as described above, cache 1202 may perform step 1302 of flowchart 1302. Cache 1202 is configured as the interface between objects and value layer constructs (e.g., EDM constructs). Cache 1202 tracks the objects that have been created, updated and deleted by application 102 (not shown in FIG. 14) by accessing object graph 1216 (as indicated by arrow 1246). For example, application 102 may transmit an indication to cache 1202 that object graph 1216 includes object change commands that are ready for processing. Cache 1202 may receive a copy of object graph 1216 from application 102, or may access object graph 1216 at application 102.

Flowchart 1500 begins with step 1502. In step 1502, at least one object level custom command is generated for at least one object modification in an object graph determined to be configured to be processed at an application level. For example, custom modification generator 1404 may generate object level custom commands for object modifications present in object graph 1216 that are determined to be processed at an application level. The generated object level custom commands may be entity-related command or relationship-related commands, such as insert, delete, or update commands (an update command may be represented as a combination of insert and delete commands). Custom modification generator 1404 may generate the object level custom commands in a similar manner as described above for custom modification generator 1204 shown in FIG. 12. In an embodiment, custom modification generator 1404 may perform step 1304 (FIG. 13) as described above for custom modification generator 1204 shown in FIG. 12, to determine object modifications in object graph 1216 that are configured to be processed at the application level.

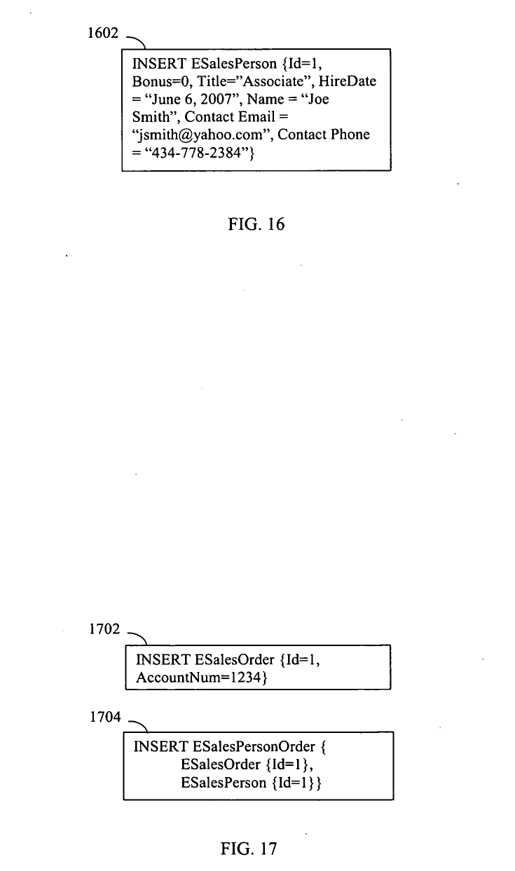

For instance, FIG. 16 shows an example object level custom command 1602 that may be generated by custom modification generator 1404 for an object modification in object graph 1216. Object level custom command 1602 is an example object level command that may be generated in an example implementation of entity schema 602 and database (relational) schema 604 of mapping 600 shown in FIG. 6. In the example of FIG. 16, object level custom command 1602 is an “insert” command related to an entity “ESalesPerson.”

In step 1504, at least one object level dynamic command is generated for at least one object modification in the object graph determined to be configured to be processed at a store level, the at least one object level dynamic command and the at least one object level custom command forming a plurality of object level commands. For example, dynamic delta expression generator 1406 may generate object level dynamic commands for object modifications present in object graph 1216 that are determined to be processed at a store level. The generated object level dynamic commands may be entity-related command or relationship-related commands, such as insert, delete, or update commands. Dynamic delta expression generator 1406 may generate the object level dynamic commands in a similar manner as described above for dynamic delta expression generator 1206 shown in FIG. 12. In an embodiment, dynamic delta expression generator 1406 may perform step 1308 (FIG. 13) as described above for dynamic delta expression generator 1206 shown in FIG. 12, to determine object modifications in object graph 1216 that are configured to be processed at the store level.

For instance, FIG. 17 shows first and second example object level dynamic commands 1702 and 1704 that may be generated by dynamic delta expression generator 1406 for an object modification in object graph 1216. Object level dynamic commands 1702 and 1704 are further examples of object level commands that may be generated in an example implementation of entity schema 602 and database (relational) schema 604 of mapping 600 shown in FIG. 6. In the example of FIG. 17, object level dynamic command 1702 is an “insert” command related to an entity “ESalesOrder,” and object level dynamic command 1704 is an “insert” command related to a relationship “ESalesPersonOrder.”

In step 1506, an identifier is assigned to each entity present in at least one of the object level commands. In an embodiment, custom modification generator 1404 is configured to assign at least one unique identifier (e.g., a number, an alphanumeric code, a string value, etc.) to each entity present in an object modification received from object graph 1216, and dynamic delta expression generator 1406 is configured to assign a unique identifier to each entity present in an object modification received from object graph 1216. Custom modification generator 1404 may assign the identifier to an entity prior to, during, or after generating the object level custom command corresponding to the object modification (step 1502). Likewise, dynamic delta expression generator 1406 may assign the identifier to an entity prior to, during, or after generating the object level dynamic command corresponding to the object modification (step 1504).

For example, as shown in FIG. 14, custom modification generator 1404 and dynamic delta expression generator 1406 may receive identifiers 1416 from identifier assigner 1402. Identifier 1402 generates identifiers 1416. Identifier assigner 1402 is configured to ensure that each instance of a particular entity receives the same unique identifier, and is configured to ensure that the same identifier is not assigned to different entities. For example, in an embodiment, identifier assigner 1402 may receive a request from custom modification generator 1404 or dynamic delta expression generator 1406 for an identifier, and may generate a new unique identifier in response to the request if the request corresponds to a new entity, or may supply a previously generated identifier in response to the request if the request corresponds to an entity that was previously assigned the previously generated identifier.

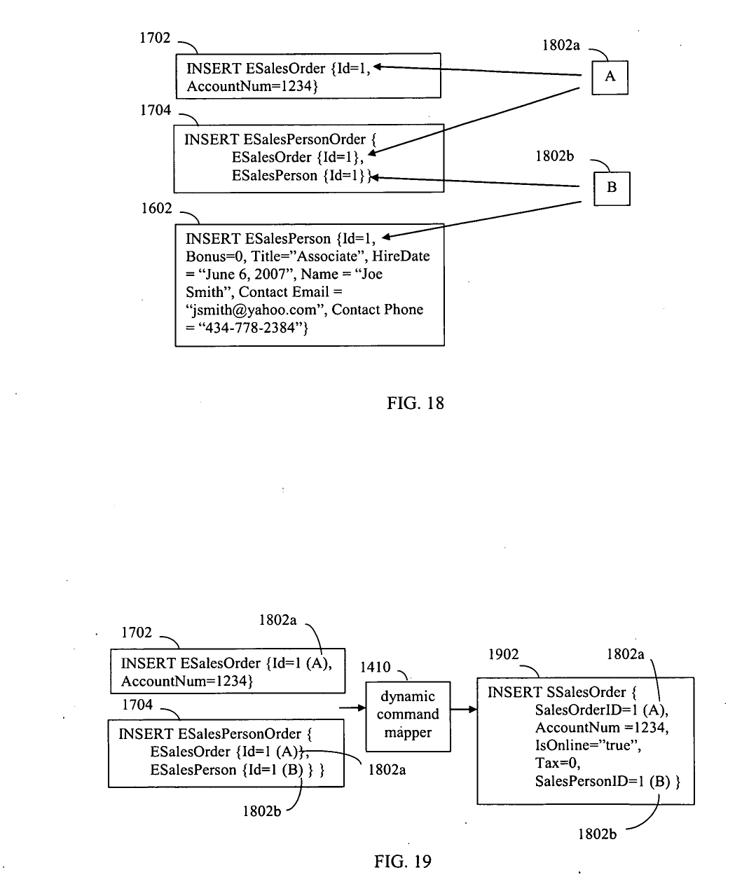

FIG. 18 illustrates an example of the assignment of identifiers, according to an embodiment. As shown in FIG. 18, a first identifier 1802a, represented as an “A,” is shown being assigned to the “Id=1” primary key of entity “ESalesOrder” of first object level dynamic command 1702. A second identifier 1802b, represented as a “B,” is shown being assigned to the “Id=1” primary key of entity “ESalesPerson” of second object level custom command 1602. For instance, identifier assigner 1402 may assign first and second identifiers 1802a and 1802b to entities “ESalesOrder” and “ESalesPerson” at the request of custom modification generator 1404 and dynamic delta expression generator 1406, respectively. Note that further identifiers 1802 may be assigned to one or both of entities “ESalesOrder” and “ESalesPerson” if desired. For instance, additional keys may be useful because model constraints may affect only a subset of the keys of a particular entity. For example, “ESalesOrder” and/or “ESalesPerson” may include further keys (e.g., may include compound or multi-part keys), and each additional key may be assigned a corresponding unique identifier by identifier assigner 1402.

In step 1508, a pair of the identifiers is assigned to each relationship present in at least one of the object level commands, the pair of identifiers assigned to a first relationship being first and second identifiers respectively assigned to first and second entities included in the first relationship. Similarly to the description above with respect to step 1506, custom modification generator 1404 may be configured to assign a pair of identifiers to each relationship present in an object modification received from object graph 1216, and dynamic delta expression generator 1406 may be configured to assign a pair of identifiers to each relationship present in an object modification received from object graph 1216. Identifier assigner 1402 may be configured to assign identifiers corresponding to entities included in relationships, and may be configured to ensure that each entity included in a relationship-related command receives the same unique identifier as is assigned to the entity in an entity-related command. In an embodiment, identifier assigner 1402 may receive a request from custom modification generator 1404 or dynamic delta expression generator 1406 for an identifier for each entity in a relationship, and may assign the identifiers in response to the request.

FIG. 18 illustrates an example of the assignment of identifiers to a relationship. As shown in FIG. 18, second object level dynamic command 1702b is a relationship-related command that includes two entities—“ESalesOrder” and “ESalesPerson.” As described above, first identifier 1802a, “A,” was assigned to the “Id=1” primary key of entity “ESalesOrder” of first object level dynamic command 1702, and second identifier 1802b, “B,” was assigned to the “Id=1” primary key of entity “ESalesPerson” of second object level custom command 1602. As such, identifier assigner 1402 is configured to assign first identifier 1802a to entity “ESalesOrder” and second identifier 1802b to entity “ESalesPerson” in the relationship of second object level dynamic command 1702b (e.g., at the request of dynamic delta expression generator 1406. Note that further identifiers 1802 may be assigned to a relationship such as second object level dynamic command 1702b. The additional identifiers correspond to any additional identifiers assigned to entities included in the relationship, as described above with respect to step 1506. For example, if “ESalesOrder” and/or “ESalesPerson” include keys that are assigned identifiers in addition to those assigned to their respective primary keys, second object level dynamic command 1702 may include the additional identifiers.

As shown in FIG. 14, custom modification generator 1404 outputs object-level custom commands 1418, which includes one or more object-level custom commands (generated according to step 1502) that include identifiers (assigned according to steps 1506 and 1508). Similarly, dynamic delta expression generator 1406 outputs object-level dynamic commands 1420, which includes one or more object-level dynamic commands (generated according to step 1504) that include identifiers (assigned according to steps 1506 and 1508).

In step 1510, the at least one object level dynamic command is converted to at least one store level dynamic command. In an embodiment, dynamic command mapper 1410 shown in FIG. 14 may be configured similarly to dynamic command mapper 1250 shown in FIG. 12. As shown in FIG. 14, dynamic command mapper 1410 receives object level dynamic commands 1420. Dynamic command mapper 1410 converts each received object level dynamic command of object level dynamic commands 1420 to one or more corresponding store-level dynamic commands. As shown in FIG. 14, dynamic command mapper 1410 generates store-level dynamic commands 1422.

For example, FIG. 19 illustrates an example of the conversion of dynamic command from object-level to store-level, according to an embodiment. As shown in FIG. 19, dynamic command mapper 1410 receives first and second object level dynamic commands 1702 and 1704, which have first and second identifiers 1802a and 1802b assigned as described above with respect to FIG. 18. Dynamic command mapper 1410 generates a store-level dynamic command 1902, which is a combination of first and second object level dynamic commands 1702 and 1704. As shown in FIG. 19, and indicated by mapping 600 shown in FIG. 6, store-level dynamic command 1902 is a store-level command—“SSalesOrder.” Store-level dynamic command 1902 includes first and second identifiers 1802a and 1802b associated with store-level constructs “SalesOrderID” and “SalesPersonID=1, respectively, which correspond to object-level entities “ESalesOrder” and “ESalesPerson.” Thus, dynamic command mapper 1410 is configured to map identifiers from entities and relationships at the object-level to corresponding store-level constructs (e.g., as defined by mapping definition 1108, shown in FIG. 11).

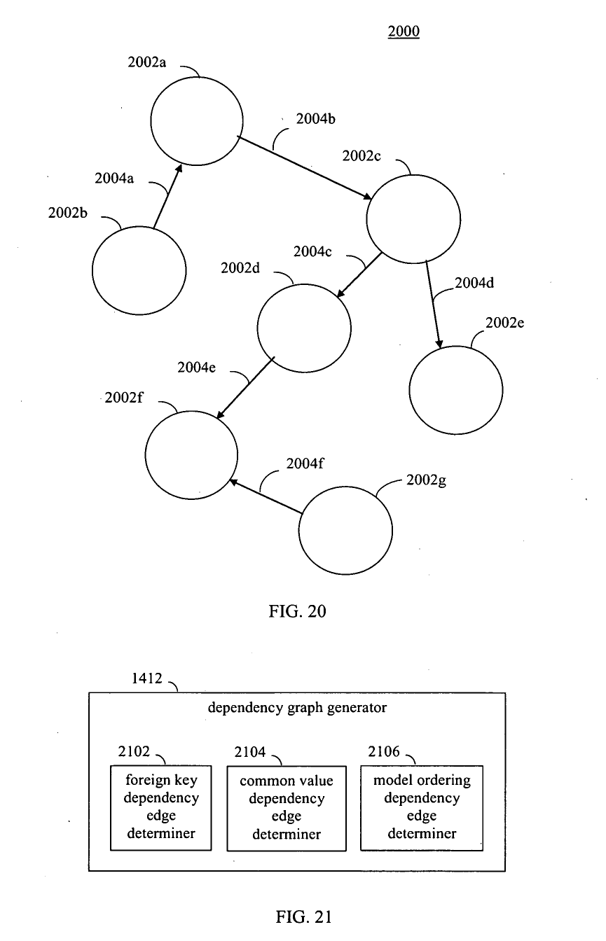

In step 1512, a dependency graph is generated that includes a plurality of nodes and an edge coupled between a pair of nodes of the plurality of nodes, each node being associated with a corresponding store level dynamic command or an object level custom command. In an embodiment, dependency graph generator 1412 shown in FIG. 14 may be configured similarly to dependency graph generator 1412 shown in FIG. 12, with differences described below. As shown in FIG. 14, dependency graph generator 1412 receives object-level custom commands 1418 and store-level dynamic commands 1420, and generates a dependency graph 1424. Dependency graph generator 1412 is configured to generate a node corresponding to each command of object-level custom commands 1418 and store-level dynamic commands 1420. For instance, FIG. 20 shows a graphical representation of an example dependency graph 2000, according to an example embodiment. As shown in FIG. 20, dependency graph 2000 includes a plurality of nodes 2002-2002g. Any number of nodes 2002 may be included in a dependency graph, corresponding to a number of object level custom commands and store level dynamic commands received by dependency graph generator 1412.

Furthermore, dependency graph generator 1412 is configured to generate edges connected between pairs of nodes to represent dependencies between the nodes in each pair. For example, as shown in FIG. 20, dependency graph 2000 includes a plurality of edges 2004a-2004f. Any number of edges 2004 may be included in a dependency graph, corresponding to a number of dependencies between the commands represented by nodes 2002. As shown in FIG. 20, each edge 2004 is shown as an arrow, to indicate a direction of each edge 2004. The direction of an edge 2004 corresponds to the direction of the dependency between the corresponding pair of nodes 2002.

In step 1514, the edge is configured according to an assigned identifier associated with the pair of nodes and a dependency between commands associated with the pair of nodes. In an embodiment, edges 2004 may be added to dependency graph 2000 based on foreign key dependencies, common value dependencies, and model ordering dependencies. For instance, FIG. 21 shows a block diagram of dependency graph generator 1412 configured to generate edges based on foreign key dependencies, common value dependencies, and model ordering dependencies, according to an example embodiment. As shown in FIG. 21, dependency graph generator 1412 may include a foreign key dependency edge determiner 2102, a common value dependency edge determiner 2104, and a model ordering dependency edge determiner 2106. Dependency graph generator 1412 may include any one or more of determiners 2102, 2104, and 2106, depending on a particular implementation. Foreign key dependency edge determiner 2102, common value dependency edge determiner 2104, and model ordering dependency edge determiner 2106 may be implemented in hardware, software, firmware, or any combination thereof.

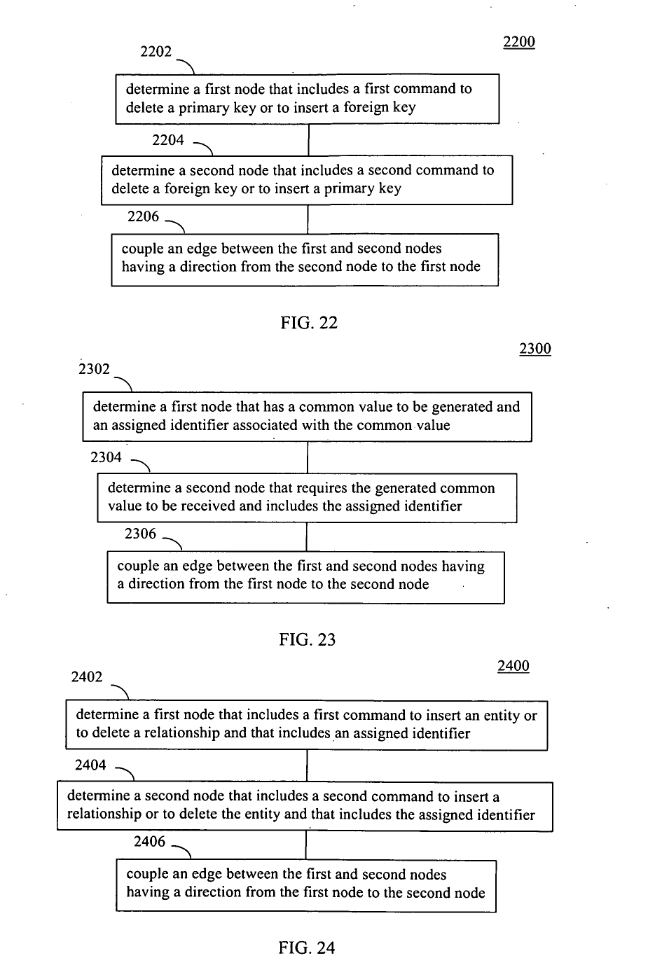

Example processes for adding edges according to foreign key dependencies, common value dependencies, and model ordering dependencies are described as follows with respect to FIGS. 22-24. The processes of FIGS. 22-24 may be performed by determiners 2102, 2104, and 2106, respectively, in an embodiment.

For instance, FIG. 22 shows a flowchart 2200 for adding edges to a dependency graph based on foreign key dependencies, according to an example embodiment. Flowchart 2200 may be performed by foreign key dependency edge determiner 2102 in an embodiment. Note that steps 2202 and 2204 may be performed in either order. Furthermore, note that with regard to flowchart 2200, an update command may be considered to be a pair of commands—an insert command and a delete command—which may then be processed as separate commands according to flowchart 2200.

Flowchart 2200 begins with step 2202. In step 2202, a first node is determined that includes a first command to delete a primary key or to insert a foreign key.

In step 2204, a second node is determined that includes a second command to delete a foreign key or to insert a primary key.

In step 2206, an edge is coupled between the first and second nodes having a direction from the second node to the first node.

FIG. 23 shows a flowchart 2300 for adding edges to a dependency graph based on common value dependencies, according to an example embodiment. Flowchart 2300 may be performed by common value dependency edge determiner 2204 shown in FIG. 22 in an embodiment. Note that steps 2302 and 2304 may be performed in either order.

Flowchart 2300 begins with step 2302. In step 2302, a first node is determined that has a common value to be generated and an assigned identifier associated with the common value.

In step 2304, a second node is determined that requires the generated common value to be received and includes the assigned identifier.

In step 2306, an edge is coupled between the first and second nodes having a direction from the first node to the second node.

FIG. 24 shows a flowchart 2400 for adding edges to a dependency graph based on model ordering dependencies, according to an example embodiment. Flowchart 2400 may be performed by model ordering dependency edge determiner 2206 shown in FIG. 22 in an embodiment. Note that steps 2402 and 2404 may be performed in either order. Furthermore, note that with regard to flowchart 2400, an update command may be ignored (not processed).

Flowchart 2400 begins with step 2402. In step 2402, a first node is determined that includes a first command to insert an entity or to delete a relationship and that includes an assigned identifier.

In step 2404, a second node is determined that includes a second command to insert a relationship or to delete the entity and that includes the assigned identifier.

In step 2406, an edge is coupled between the first and second nodes having a direction from the first node to the second node.

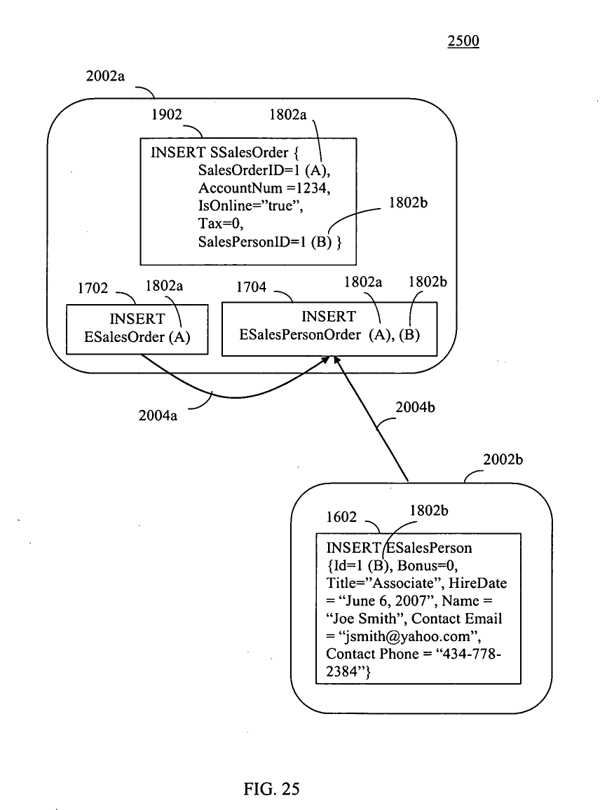

FIG. 25 illustrates a graphical depiction of a dependency graph 2500, according to an example embodiment. Dependency graph 2500 is shown to illustrate the generation of example edges, and is not intended to be limiting. Dependency graph 2500 may be generated by dependency graph generator 1412 shown in FIG. 14 based on custom command 1602 shown in FIG. 16 and store-level dynamic command 1902 shown in FIG. 19, for example. As shown in FIG. 25, a first node 2002a is present that corresponds to store-level dynamic command 1902, and a second node 2002b is present that corresponds to custom command 1602. Store-level dynamic command 1902, portions of object-level dynamic commands 1702 and 1704, and custom command 1602 are shown in nodes 2002a and 2002b in FIG. 25 for purposes of illustration. Store-level dynamic command 1902 is configured to insert a new row in the SSalesOrders table (illustrated in FIG. 6) in database 106. Custom command 1602 is configured to insert an ESalesPerson (object-level).

As shown in FIG. 25, dependency graph 2500 includes a first edge 2004a and a second edge 2004b. In the example of FIG. 25, first and second edges 2004a and 2004b are generated due to model ordering dependencies. Edges 2004a and 2004b may be generated according to flowchart 2400 in FIG. 24 (e.g., by model ordering dependency edge generator 2106). For instance, with respect to edge 2004a, in step 2402, a first node—node 2002a—is determined that includes a first command to insert an entity—“ESalesOrder” as identified by identifier 1802a, “A.” In step 2404, a second node—node 2002a—is determined that includes a second command to insert a relationship—previously “ESalesPersonOrder” in command 1704, now SalesPersonID in command 1902—that includes the identifier—identifier 1802a, “A.” Thus, in step 2406, an edge—edge 2004a—is coupled between the first and second nodes, having a direction from the first node to the second node (from node 2002a back to node 2002a).

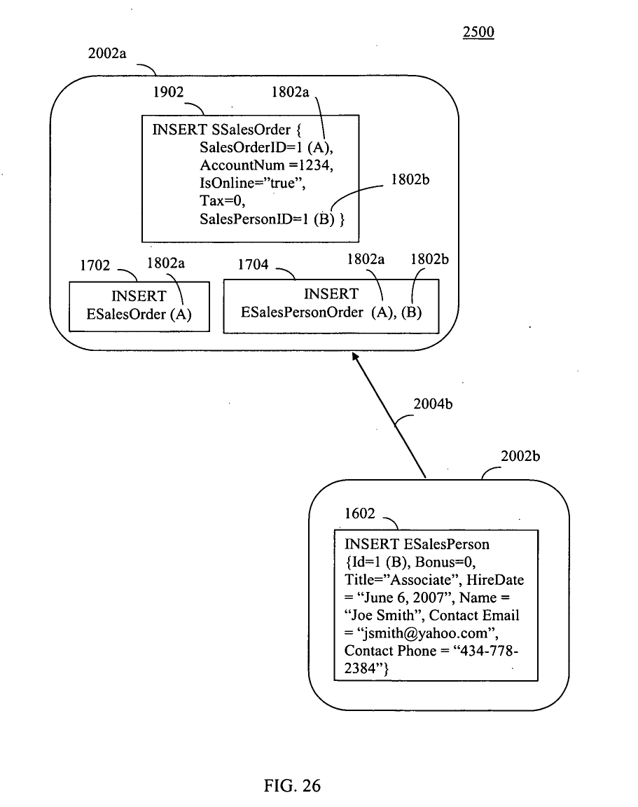

As shown in FIG. 25, first edge 2004a is added to dependency graph 2500, with a direction from node 2002a back to node 2002a. Because edge 2004a begins and ends at the same node, edge 2004a can be eliminated. This is because store level dynamic command 1902 handles both of object level dynamic commands 1702 and 1704 in a single command, and therefore no ordering problem can occur. Thus, dependency graph 2500 can be generated to not include edge 2004a. For instance, FIG. 26 shows dependency graph 2500 of FIG. 25 without edge 2004a, which is eliminated.

With respect to edge 2004b, referring back to flowchart 2400, in step 2402, a first node—node 2002b—is determined that includes a first command to insert an entity—“ESalesPerson”—that includes an identifier—identifier 1802b, “B.” In step 2404, a second node—node 2002a—is determined that includes a second command to insert a relationship (previously “ESalesPersonOrder” in command 1704, now SalesPersonID in command 1902) that includes identifier 1802b, “B.” Thus, in step 2406, an edge—edge 2004b—is coupled between the first and second nodes—nodes 2002b and 2004a, respectively—having a direction from the first node to the second node. As shown in FIG. 25, second edge 2004b is added to dependency graph between nodes 2004a and 2040b, with a direction from node 2002b to node 2002a.

In this manner, the store command—store-level dynamic command 1902—is enabled to be handed as an object-level command, due to the presence of identifiers 1802a and 1802b. Identifiers 1802a and 1802b enable object-level command features of store-level dynamic command 1902 to be determined, by providing a reference back to object-level dynamic commands 1702 and 1704. Although store-level dynamic command 1902 is merely inserting a row into SSalesOrder, the value identifiers 1802a and 1802b, “A” and “B,” enable the object-level dynamic commands 1702 and 1704 responsible for inserting ESalesOrder “A” and inserting the ESalesPersonOrder relationship from “A” to “B” to be ascertained.

Referring to FIG. 25, in another example, second edge 2004b (or an additional edge between from node 2002b to 2002b) may be generated due to a common value dependency. For example, when the insert command for the entity “ESalesPerson” of object level custom command 1602 is generated, the value for the primary key “ID” of “ESalesPerson” (which is shown as 1 in FIG. 25) may not be known. Instead, the value for the primary key may be generated later, such as after object level custom command 1602 is received by database 106. As such, value of “SalesPersonID” in the insert command for “SSalesOrder” in store level dynamic command 1902, which is the same value as the value for the primary key “ID” of “ESalesPerson,” is not known. In such case, the insert command of object level custom command 1602 needs to be performed prior to the insert command of store level dynamic command 1902 so that the value for the primary key “ID” can be provided to “SalesPersonID.” This is a common value dependency.

In such an example, edge 2004b may be generated according to flowchart 2300 in FIG. 23 (e.g., by common value dependency edge generator 2104) to provide the common value dependency in dependency graph 2500. In step 2302, a first node having a common value to be generated is determined, which is second node 2002b (corresponding to object level custom command 1602 that has the value for the primary key “ID” of “ESalesPerson” to be generated). As shown in FIG. 25, the primary key “ID” of “ESalesPerson” is assigned second identifier 1802b, “B.” In step 2304, a second node requiring the generated common value to be received is determined, which is first node 2002a. First node 2002a is determined to be the node requiring the generated common value to be received because the identifier of “SalesPersonID”—second identifier 1802b, “B”—matches the identifier of the “ESalesPerson” primary key “ID” of node 2002b. In step 2306, an edge is coupled between the first and second nodes—nodes 2002b and 2002a—having a direction from the first node to the second node (i.e., from second node 2002b to first node 2002a).

Referring back to flowchart 1500 in FIG. 15, in step 1516, a topological sort of the dependency graph is performed to determine an execution order of the store level dynamic commands and the object level custom commands. For example, topological sorter 1414 may be generally similar to topological sorter 1220 shown in FIG. 12 and described above. Topological sorter 1414 may receive dependency graph 1236, and may be configured to perform a topological sort of dependency graph 1424. Dependency graph 1424 may be provided in any forming, including in the form of a list of commands, associated nodes, edges, and edge directions. The topological sort of dependency graph 1424 generates an order of execution of the commands associated with the nodes of dependency graph 1424 based on the edges of dependency graph. Topological sorter 1414 may be configured to perform any suitable conventional or proprietary topological sort routine. Numerous topological sort routines are well known to persons skilled in the relevant art(s). As shown in FIG. 14, topological sorter 1414 generates ordered dynamic and custom commands 1238.

For instance, referring to dependency graph 2500 shown in FIG. 26, store level dynamic command 1902 and object level custom command 1602 are the two commands that are present, corresponding to nodes 2002a and 2002b. Topological sorter 1414 may determine that object level custom command 1602 is to be executed first, and store level dynamic command 1902 is to be executed second, due to the direction of edge 2004b from object level custom command 1602 to store level dynamic command 1902.

Subsequent to step 1516, further steps of flowchart 1300 shown in FIG. 13 may be performed, such as steps 1318, 1320, and/or 1322.

### V. Conclusion

Devices in which embodiments may be implemented may include storage, such as storage drives, memory devices, and further types of computer-readable media. Examples of such computer-readable media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable media may store program modules that include logic for implementing ORM runtime module 1400 shown in FIG. 14, any one or more of the elements thereof, dependency graph generator 1412 shown in FIGS. 14 and 21, including any one or more of foreign key dependency edge determiner 2102, common value dependency edge determiner 2104, and/or model ordering dependency edge determiner 2106 shown in FIG. 21, flowchart 1300 of FIG. 13, flowchart 1500 of FIG. 15, flowchart 2200 of FIG. 22, flowchart 2300 of FIG. 23, flowchart 2400 of FIG. 24, and/or any other flowchart herein, and/or further embodiments of the present invention described herein. Embodiments are directed to computer program products comprising such logic (e.g., in the form of software) stored on any computer useable medium. Such software, when executed in one or more data processing devices, causes a device to operate as described herein.

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for object relational mapping, comprising:
generating at least one object level custom command for at least one object modification in an object graph determined to be configured to be processed at an application level;
generating at least one object level dynamic command for at least one object modification in the object graph determined to be configured to be processed at a store level, the at least one object level dynamic command and the at least one object level custom command forming a plurality of object level commands;
assigning an identifier to each entity present in the object level commands;
assigning a pair of the identifiers to each relationship present in the object level commands, the pair of identifiers assigned to a first relationship being first and second identifiers respectively assigned to first and second entities included in the first relationship;
converting the at least one object level dynamic command to at least one store level dynamic command;
generating a dependency graph that includes a plurality of nodes and an edge coupled between a pair of nodes of the plurality of nodes, each node being associated with a corresponding store level dynamic command or an object level custom command;
configuring the edge according to an assigned identifier associated with the pair of nodes and a dependency between commands associated with the pair of nodes; and
performing a topological sort of the dependency graph to determine an execution order of the store level dynamic commands and the object level custom commands.

2. The method of claim 1, wherein said configuring the edge according to an assigned identifier associated with the pair of nodes and a dependency between commands associated with the pair of nodes comprises:
configuring the edge according to a foreign key dependency between the commands associated with the pair of nodes.

3. The method of claim 1, wherein said configuring the edge according to an assigned identifier associated with the pair of nodes and a dependency between commands associated with the pair of nodes comprises:
determining a first node associated with a first command to delete a primary key or to insert a foreign key;
determining a second node associated with a second command to delete a foreign key or to insert a primary key; and
coupling the edge between the first and second nodes to have a direction from the second node to the first node.

4. The method of claim 1, wherein said configuring the edge according to an assigned identifier associated with the pair of nodes and a dependency between commands associated with the pair of nodes comprises:
configuring the edge according to a common value dependency between the commands associated with the pair of nodes.

5. The method of claim 1, wherein said configuring the edge according to an assigned identifier associated with the pair of nodes and a dependency between commands associated with the pair of nodes comprises:
determining a first node associated with a common value to be generated and an assigned identifier associated with the common value;
determining a second node that requires the generated common value to be received and includes the assigned identifier; and
coupling the edge between the first and second nodes to have a direction from the first node to the second node.

6. The method of claim 1, wherein said configuring the edge according to an assigned identifier associated with the pair of nodes and a dependency between commands associated with the pair of nodes comprises:
configuring the edge according to a model ordering dependency between the commands associated with the pair of nodes.

7. The method of claim 1, wherein said configuring the edge according to an assigned identifier associated with the pair of nodes and a dependency between commands associated with the pair of nodes comprises:
determining a first node associated with a first command to insert an entity or to delete a relationship and that includes an assigned identifier;
determining a second node associated with a second command to insert a relationship or to delete the entity and that includes the assigned identifier; and
coupling the edge between the first and second nodes to have a direction from the first node to the second node.

8. An object relational mapping (ORM) system, comprising:
a dependency graph generator that receives at least one object level custom command and at least one store level dynamic command, the at least one store level dynamic command being generated from at least one object level dynamic command, an identifier being assigned to each entity present in the at least one object level custom command and to each entity present in the at least one object level dynamic command, the at least one store level dynamic command including any identifiers assigned in the at least one object level dynamic command;
the dependency graph generator being configured to generate a dependency graph that includes a plurality of nodes and an edge coupled between a pair of nodes of the plurality of nodes, each node being associated with a corresponding store level dynamic command or an object level custom command; and
the dependency graph generator being configured to configure the edge according to an assigned identifier associated with the pair of nodes and a dependency between commands associated with the pair of nodes.

9. The ORM system of claim 8, wherein the dependency is a foreign key dependency, a common value dependency, or a model ordering dependency.

10. The ORM system of claim 8, wherein the dependency graph generator includes a foreign key dependency edge determiner, the foreign key dependency edge determiner being configured to determine a first node associated with a first command to delete a primary key or to insert a foreign key, to determine a second node associated with a second command to delete a foreign key or to insert a primary key, and to couple the edge between the first and second nodes to have a direction from the second node to the first node.

11. The ORM system of claim 8, wherein the dependency graph generator includes a common value dependency edge determiner, the common value dependency edge determiner being configured to determine a first node associated with a common value to be generated and an assigned identifier associated with the common value, to determine a second node that requires the generated common value to be received and includes the assigned identifier, and to couple the edge between the first and second nodes to have a direction from the first node to the second node.

12. The ORM system of claim 8, wherein the dependency graph generator includes a model ordering dependency edge determiner, the model ordering dependency edge determiner being configured to determining a first node associated with a first command to insert an entity or to delete a relationship and that includes an assigned identifier, to determine a second node associated with a second command to insert a relationship or to delete the entity and that includes the assigned identifier, and to couple the edge between the first and second nodes to have a direction from the first node to the second node.

13. The ORM system of claim 8, further comprising:
a topological sorter configured to perform a topological sort of the dependency graph to determine an execution order of the store level dynamic commands and the object level custom commands.

14. A method for generating a dependency graph, comprising:
receiving at least one object level custom command and at least one store level dynamic command, the at least one store level dynamic command being generated from at least one object level dynamic command, an identifier being assigned to each entity present in the at least one object level custom command and to each entity present in the at least one object level dynamic command, the at least one store level dynamic command including any identifiers assigned in the at least one object level dynamic command;
generating a dependency graph that includes a plurality of nodes and an edge coupled between a pair of nodes of the plurality of nodes, each node being associated with a corresponding store level dynamic command or an object level custom command; and
configuring the edge according to an assigned identifier associated with the pair of nodes and a dependency between commands associated with the pair of nodes.

15. The method of claim 14, wherein said configuring the edge according to an assigned identifier associated with the pair of nodes and a dependency between commands associated with the pair of nodes comprises:
configuring the edge according to an assigned identifier associated with the pair of nodes and a foreign key dependency, a common value dependency, or a model ordering dependency between commands associated with the pair of nodes.

16. The method of claim 14, wherein said configuring the edge according to an assigned identifier associated with the pair of nodes and a dependency between commands associated with the pair of nodes comprises:
determining a first node associated with a first command to delete a primary key or to insert a foreign key;
determining a second node associated with a second command to delete a foreign key or to insert a primary key; and
coupling the edge between the first and second nodes to have a direction from the second node to the first node.

17. The method of claim 14, wherein said configuring the edge according to an assigned identifier associated with the pair of nodes and a dependency between commands associated with the pair of nodes comprises:
determining a first node associated with a common value to be generated and an assigned identifier associated with the common value;
determining a second node that requires the generated common value to be received and includes the assigned identifier; and
coupling the edge between the first and second nodes to have a direction from the first node to the second node.

18. The method of claim 14, wherein said configuring the edge according to an assigned identifier associated with the pair of nodes and a dependency between commands associated with the pair of nodes comprises:
determining a first node associated with a first command to insert an entity or to delete a relationship and that includes an assigned identifier;
determining a second node associated with a second command to insert a relationship or to delete the entity and that includes the assigned identifier; and
coupling the edge between the first and second nodes to have a direction from the first node to the second node.
